(19) United States
(12) Patent Application Publication
(10) Pub. No.: US 2016/0253042 A1
(43) Pub. Date: Sep. 1, 2016

(54) DISPLAY PROCESS APPARATUS, DISPLAY PROCESS METHOD, AND NON-TRANSITORY COMPUTER-READABLE RECORDING MEDIUM

(71) Applicant: FUJITSU LIMITED, Kawasaki-shi (JP)

(72) Inventor: Hideyuki Niwa, Numazu (JP)

(73) Assignee: FUJITSU LIMITED, Kawasaki-shi (JP)

(21) Appl. No.: 15/151,267

(22) Filed: May 10, 2016

Related U.S. Application Data
(63) Continuation of application No. PCT/JP2013/080509, filed on Nov. 12, 2013.

(51) Int. Cl. G06F 3/041; G06F 3/0354

(52) U.S. Cl. CPC G06F 3/0418; G06F 3/03547

(57) ABSTRACT

A display process apparatus includes a screen and a processor that executes a process. The process includes identifying a first point in a display area of the screen according to an input operation performed on the display process apparatus, and distinguishably displaying a second point in the display area. The second point is positioned a predetermined distance from the first point. The second point is positioned on a half-straight line extending toward the first point from a predetermined point that is set at an edge part of the display area.

### CROSS-REFERENCE TO RELATED APPLICATIONS

This application is a U.S. continuation application filed under 35 USC 111(a) claiming benefit under 35 USC 120 and 365(c) of PCT application PCT/JP 2013/080509, filed on Nov. 12, 2013. The foregoing applications are hereby incorporated herein by reference.

### FIELD

The embodiments discussed herein are related to a display process apparatus, a display process method, and a non-transitory computer-readable recording medium.

### BACKGROUND

A display process apparatus including a touch panel or the like receives data in response to a predetermined operation performed on the touch panel by an operator (hereinafter also referred to as “user”). When the user performs an input operation (pointing) by touching a screen displayed on the touch panel in a case of performing the operation, the display process apparatus recognizes the coordinates corresponding to the pointed position of the screen to be the designated coordinates. Further, the display process apparatus performs, for example, the selection of an icon that is displayed on the screen in accordance with the recognized coordinates. Further, the display process apparatus performs, for example, execution of an application (hereinafter also referred to as “appli”).

### RELATED ART DOCUMENT

### Patent Document 1: Japanese Laid-Open Patent Publication No. 11-24841

### Patent Document 2: Japanese Laid-Open Patent Publication No. 8-76927

### SUMMARY

According to an aspect of the invention, there is provided a display process apparatus includes a screen and a processor that executes a process. The process includes identifying a first point in a display area of the screen according to an input operation performed on the display process apparatus, and distinguishably displaying a second point in the display area. The second point is positioned a predetermined distance from the first point. The second point is positioned on a half-straight line extending toward the first point from a predetermined point that is set at an edge part of the display area.

The object and advantages of the invention will be realized and attained by means of the elements and combinations particularly pointed out in the claims.

It is to be understood that both the foregoing general description and the followed detailed description are exemplary and explanatory and are not restrictive of the invention, as claimed.

### BRIEF DESCRIPTION OF DRAWINGS

FIG. 1 is a diagram illustrating an example of a functional configuration of a display process apparatus according to an embodiment of the present invention;

FIG. 2 is a diagram illustrating an example of a hardware configuration of a display process apparatus according to an embodiment of the present invention;

FIG. 3 is a diagram illustrating an example of a flowchart of processes performed by a display process apparatus according to an embodiment of the present invention;

FIG. 4 is a diagram illustrating an example of a flowchart of processes performed by a display process apparatus according to an embodiment of the present invention;

FIGS. 5A and 5B are diagrams illustrating examples of displaying a pointer cursor by using a position adjustment mode according to a first embodiment;

FIG. 6 is a diagram for describing a pointer cursor display position in a case where a screen is touched with a finger;

FIGS. 7A to 7C are diagrams illustrating examples in which a pointer cursor display position is switched according to a position adjustment mode of a first embodiment;

FIGS. 8A and 8B are diagrams illustrating examples of displaying a pointer cursor in a case where an upper edge center of a screen is set as a reference point;

FIGS. 9A to 9C are diagrams illustrating examples of displaying a pointer cursor in a position adjustment mode according to a second embodiment;

FIGS. 10A to 10C are diagrams illustrating examples of displaying a pointer cursor in a case where an upper left corner of a screen is set as a reference point;

FIGS. 11A to 11C are diagrams illustrating examples of displaying a pointer cursor in a position adjustment mode according to a third embodiment;

FIGS. 12A to 12D are diagrams illustrating examples of displaying a pointer cursor in a fixed mode according to a first embodiment;

FIGS. 13A to 13D are diagrams illustrating examples of displaying a pointer cursor in a fixed mode according to a second embodiment;

FIGS. 14A to 14C are diagrams illustrating examples of the shapes of a pointer cursor;

FIGS. 15A to 15E are diagrams illustrating examples of the display positions of a pointer cursor;

FIGS. 16A to 16F are diagrams illustrating a first applied example to which an embodiment of the present invention is applied;

FIGS. 17A and 17B are diagrams illustrating a second applied example to which an embodiment of the present invention is applied;

FIGS. 18A and 18B are diagrams illustrating a third applied example to which an embodiment of the present invention is applied;

FIGS. 19A and 19B are diagrams illustrating a fourth applied example to which an embodiment of the present invention is applied;

FIGS. 20A and 20B are diagrams illustrating a fifth applied example to which an embodiment of the present invention is applied; and

FIGS. 21A and 21B are diagrams illustrating examples of displaying a pointer cursor by using an arrangement of a button(s);

### DESCRIPTION OF EMBODIMENTS

In a case where the coordinates corresponding to the pointed position in the displayed screen are recognized as the designated coordinates, the position in which the designated coordinates are displayed on the screen may overlap with or be proximal to the position being pointed by the user. Therefore, the designated coordinates may become hidden by the user's finger or the like when the corresponding position in the screen is being pointed by the user. As a result, the user cannot directly see (confirm) the position of the designated coordinates displayed on the screen. Visual confirmation of the position of the designated coordinates displayed on the screen is particularly difficult in a case of using the user's finger for pointing compared to a case of using a stylus or the like for pointing.

Next, embodiments of the present invention are described with reference to the accompanying drawings.

### <Functional Configuration of Input Device>

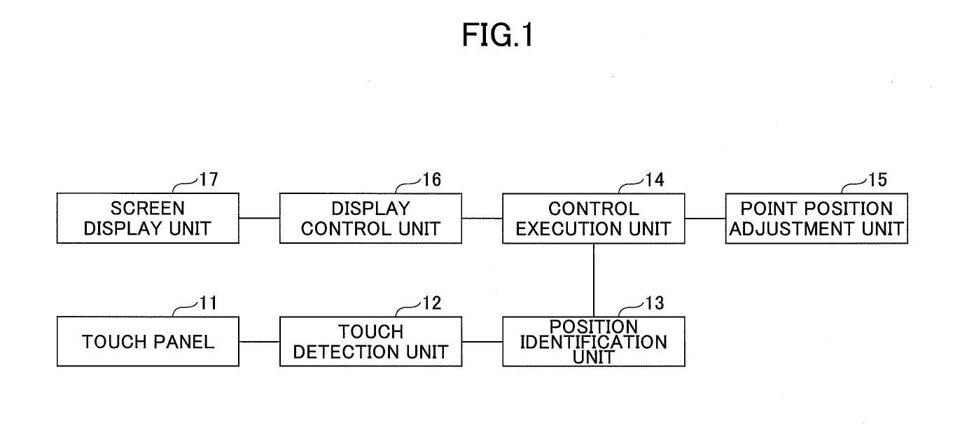

FIG. 1 is a diagram illustrating an example of a functional configuration of a display process apparatus according to an embodiment of the present invention. The display process apparatus 10 illustrated in FIG. 1 is, for example, a data device that controls input. The display process apparatus 10 may be, for example, a tablet terminal, a smartphone, a Personal Digital Assistant (PDA), and a mobile phone. Further, the display process apparatus may be, for example, a Personal Computer (PC), a server, a game device, or a music player device.

The display process apparatus 10 includes a touch panel 11, a touch detection unit 12, a position identification unit 13, a control execution unit 14, a point position adjustment unit 15, a display control unit 16, and a screen display unit (display unit) 17.

The touch panel 11 is an input unit that accepts (receives) various data to be input to the display process apparatus 10. The touch panel 11 obtains data of the position of a finger or the like by detecting a minute current of a user's finger contacting a screen or the pressing of a finger, a stylus, or the like on a screen. Although the position of the finger, stylus, etc., can be detected by using methods such as a resistive film method, an electrostatic capacitance method, an infrared method, or an electromagnetic method, other methods may also be used.

Further, the touch panel 11 may obtain the positions of multiple fingers simultaneously. Further, the touch panel 11 may trace the movement of a finger along with the passing of time and obtain data input by the finger.

The touch panel 11 may be a touch-panel display that is integrally formed with a display (screen display unit 17). The control content that is based on data input to the touch panel 11 is displayed on a display by the touch panel 11.

The touch detection unit 12, which is an example of a sensor control unit, detects that a user's finger, a stylus, or the like has contacted (touched) the touch panel 11. When the touch panel 11 receives a touch operation by the user's finger or the like, the touch detection unit 12 obtains data input by the touch operation such as the position of the touch, the number of touches, or the moving direction of the finger.

Note that, the touch detection unit 12 not only may obtain the data of the position (coordinates) of the finger at a certain point but may also trace the movement of the finger along the passing of time at intervals of a few seconds and obtain data of the movement of the finger based on the content of the trace (path of the movement). Thereby, the touch detection unit 12 can detect various operations such as a swiping movement (e.g., a movement in which a finger slides (moves) on a screen in a state where the finger is contacting the screen) or a flicking movement (e.g., a light stroking movement performed on a screen), a tapping or rotating a finger on a screen.

The position identification unit 13 identifies a touch position (first point) corresponding to an input operation based on a detection result of the touch detection unit 12. In a case where coordinates are designated together with the input operation, the position detection unit 13 assumes that the position of a pointer cursor is a point designated by pointing (point designation).

The control execution unit 14 controls the content of various operations (e.g., activation, termination, or the switching of applications and programs, the setting of a parameters) based on the position data (coordinates) identified by the position identification unit 13 according to the detection results of the touch detection unit 12. For example, the control execution unit 14 performs selection/movement of an icon or button displayed in a display area of the screen display unit 17 or scrolling of contents based on a touch position detected by the touch detection unit 12. Further, the control execution unit 14 controls the selection or input of characters or the like in an input area included the contents (e.g., checkbox, textbox). The various controls described above are executed by, for example, various application and programs included in the display control unit 16.

Of the multiple applications installed beforehand in the display process apparatus 10 to be executed by the control execution unit 14, the control execution unit 14 executes, for example, a predetermined application corresponding to the control content of the position identification unit 13. Note that an “application” may be software that performs text-editing or spreadsheet calculation. An “application may also be a basic application used to execute a typical action such as a scrolling action or a screen-changing action responsive to a swiping movement or a tapping movement, or an action for activating a browser.

Note that, although each of the applications is executed in an Operating System (OS) such as Android (registered trademark), Windows (registered trademark), or Linux (registered trademark), other Operating Systems or the like may be used to execute the applications.

The point position adjustment unit 15 adjusts the position at which the pointer cursor is displayed in response to a position (first point) that is touched by the user (touch position). The point position adjustment unit 15 uses, for example, a predetermined calculation formula to calculate a target point located a predetermined distance from the touch position. The target point is situated within a display area of a screen and positioned on a half-straight line extending toward the touch position from a reference point (predetermined point) that is set at an edge part of the display area of the screen. Further, the point position adjustment unit 15 assumes the calculated target point to be the position at which the pointer cursor is to be displayed (second point).

More specifically, the point that is situated within the display area and located further part from the touch position than the predetermined point is set to be the second point by the point position adjustment unit. In a case where the distance between the touch position (first point) and the predetermined point is less than a predetermined value, the point position adjustment unit 15 changes (adjusts) the distance between the touch position and the pointer cursor according to the distance between the predetermined point and the touch position.

Note that the point position adjustment unit 15 may change the predetermined point in a case where the touch position is determined to be in a position that is set beforehand. For example, the point position adjustment 15 may change the position of the predetermined point in a case where a predetermined condition is satisfied (e.g., when the touch position obtained by the position identification unit 13 reaches the edge part of the display area). However, the predetermined condition for changing the position of the predetermined point is not limited in particular.

The point position adjustment unit 15 adjusts the position at which the pointer cursor is displayed on the screen of the screen display unit 17. The point position adjustment unit 15 may make the adjustment based on a predetermined display mode for displaying the pointer cursor (e.g., position adjustment mode, fixed mode) or according to a predetermined calculation formula corresponding to the display mode.

The display control unit 16 displays the display content obtained by the control execution unit 15. In addition, the display control unit 16 distinguishably displays the pointer cursor according to a position (coordinates) within the display area adjusted by the point position adjustment unit 15.

The screen display unit 17 is an output unit that displays on a screen the display content controlled by the display control unit 16. Note that the screen display unit 17 may integrally form a united body with the touch panel 11. In this case where the screen display unit 17 and the touch panel 11 form a united body, the touch panel 11 and the screen display unit 17 serve as an all-in one input/output unit. Owing the above-described embodiment, the operability of the user's input to the display process apparatus 10 can be improved.

### <Example of Hardware Configuration of Display Process Apparatus>

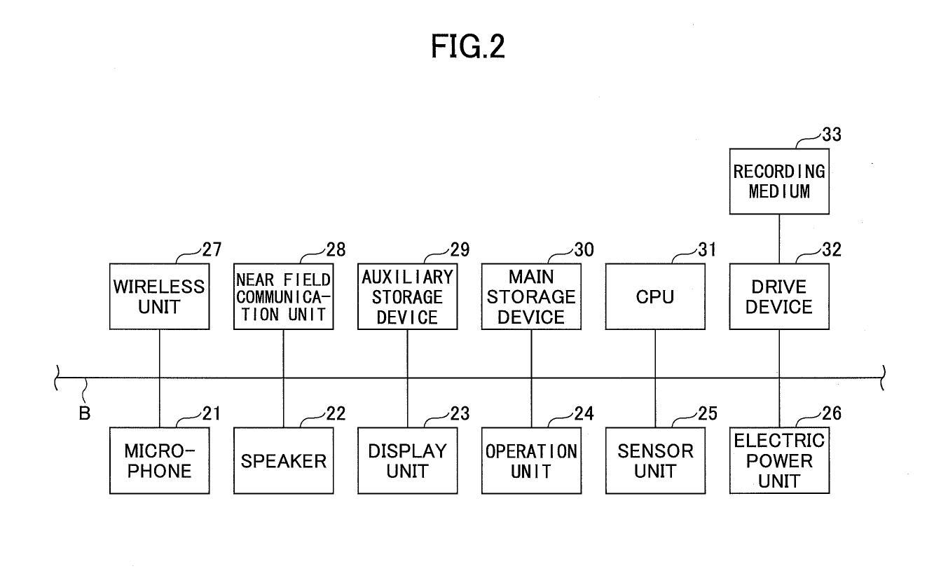

FIG. 2 is a diagram illustrating an example of a hardware configuration of the display process apparatus 10 according to an embodiment of the present invention.

According to the example depicted in FIG. 2, the display process apparatus 10 includes a microphone (hereinafter referred to as “mic”) 21, a speaker 22, a display unit 23, an operation unit 24, a sensor unit 25, an electric power unit 26, a wireless unit 27, a short distance communication unit 28, an auxiliary storage device 29, a main storage device 30, a processor (Central Processing Unit (CPU)) 31, and a drive device 32 that are connected to each other by a bus B.

The microphone 21 inputs a user's audio and other sounds. The speaker 22 outputs audio of a communication counterpart or a sound such as a ring tone. Although the mic 21 and the speaker 22 may be used for conversing with a communication counterpart by way of a telephone function, the mic 21 and the speaker 22 may be used for other purposes such as inputting and outputting information by audio.

The display unit 23 displays a screen, that is set according to an OS or various applications, to the user. The display unit 23 may be a touch-panel display including the touch panel 11 and the screen display unit 17. In this case where the display unit 23 is a touch-panel display, the display unit 23 functions as an input/output unit.

The display unit 23 includes a display such as a Liquid Crystal Display (LCD) or an organic Electro Luminescence (EL) display.

The operation unit 24 includes, for example, operation buttons displayed on the screen of the display unit 24 and operation buttons provided on an external part of the display process apparatus 10. The operation buttons may include, for example, a power button for turning electric power on/off, a volume adjustment button for adjusting volume output from the speaker 22, and other operation buttons. Further, the operation button may also include an operation key for inputting characters aligned in a predetermined order.

In a case where, for example, the user performs a predetermined operation on a screen of the display unit 23 or presses the operation button, the display unit 23 detects a touch position on the screen or a gesture (e.g., swiping movement) performed on the screen. The display unit 23 also displays information such as an application execution result, contents, an icon, a cursor on the screen.

The sensor unit 25 detects movement performed on the display process apparatus 10 at a certain timing or movement continuously performed on the display process apparatus 10. For example, the sensor unit 25 detects the tilt angle, acceleration, direction, and position of the display process apparatus 10. However, the sensor unit 25 is not limited to detecting the above. The sensor unit 25 of this embodiment may be a tilt sensor, an acceleration sensor, a gyro sensor, or a GPS. However, the sensor unit 25 is not limited to these sensors.

The electric power unit 26 supplies electric power to each of the components/parts of the display process apparatus 10. The electric power unit 26 in this embodiment may be an internal power source such as a battery. However, the electric power unit 26 is not limited to a battery. The power unit 26 may also detect the amount of power constantly or intermittently at predetermined intervals and monitor, for example, the remaining amount of electric power.

The wireless unit 27 is a transmission/reception unit of communication data for receiving wireless signals (communication data) from a base station using an antenna or the like and transmitting wireless signals via an antenna or the like.

The short distance communication unit 28 performs short distance communication with another device by using a communication method such as infrared communication, Wi-Fi (registered trademark) or Bluetooth (registered trademark). The wiring unit 27 and the short distance communication unit 28 are communication interfaces that enable transmission/reception of data with another device.

The auxiliary storage device 29 is a storage unit such as a Hard Disk Drive (HDD) or a Solid State Drive (SSD). The auxiliary storage device 29 stores various programs and the like and inputs/outputs data according to necessity.

The main storage device 30 stores execution programs or the like read out from the auxiliary storage device 29 according to instructions from the CPU 31 and also stores various information obtained during the execution of a program or the like. The main storage device 30 in this embodiment is a Read Only Memory (ROM) or a Random Access Memory (RAM). However, the main storage device 30 is not limited to these memories.

The CPU 31 implements various processes for controlling input by controlling the processes of the entire computer (e.g., various calculations, data input/output of each hardware component) based on a control program (e.g., OS) and an execution program stored in the main storage device 30. The various information required during the execution of a program may be obtained from the auxiliary storage device 29 and the results of the execution of the program may be stored in the auxiliary storage device 29.

The drive device 32 can be detachably attached with, for example, the recording medium 33 to read various information recorded on the recording medium 33 and write predetermined information on the recording medium 33. The drive device 32 in this embodiment is a medium installment slot. However, the drive device 32 is not limited to the above.

The recording medium 33 is a computer-readable recording medium on which the execution program or the like is recorded. The recording medium 33 may be, for example, a semiconductor memory such as a flash memory. The recording medium 33 may also be a portable type recording medium such as a Universal Serial Bus (USB). However, the recording medium 33 is not limited to the above.

In this embodiment, processes such as the display process can be implemented with the cooperation of hardware resources and software by installing an execution program (e.g., display process program) in the above-described hardware configuration of the computer body. Further, the display process program corresponding to the above-described display process may be reside in the input device or be activated in response to an activation instruction.

### <Example of Process of Display Process Apparatus>

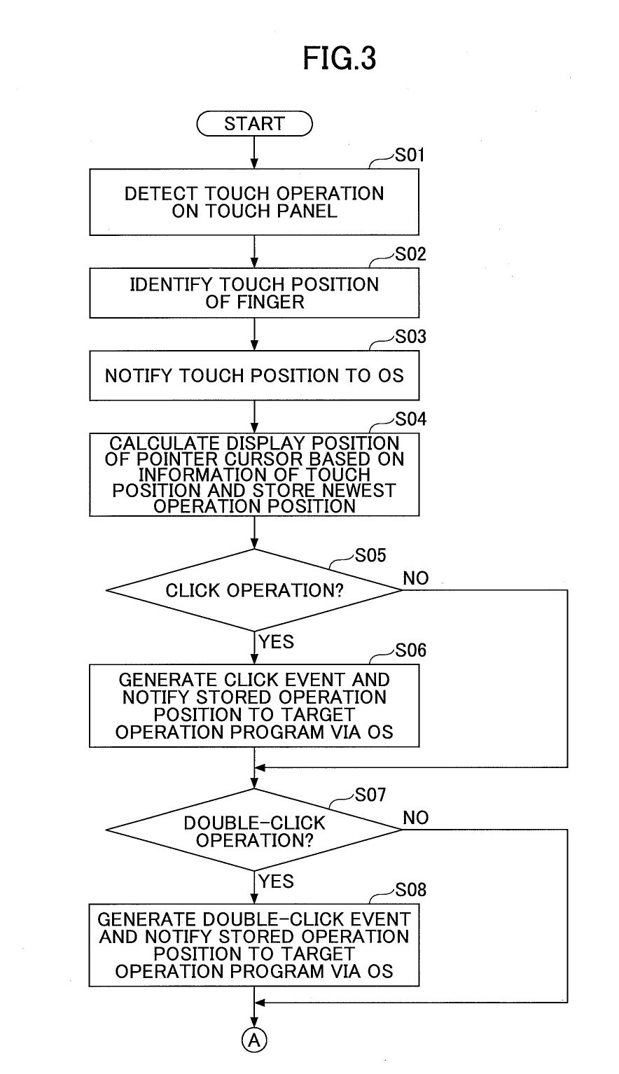

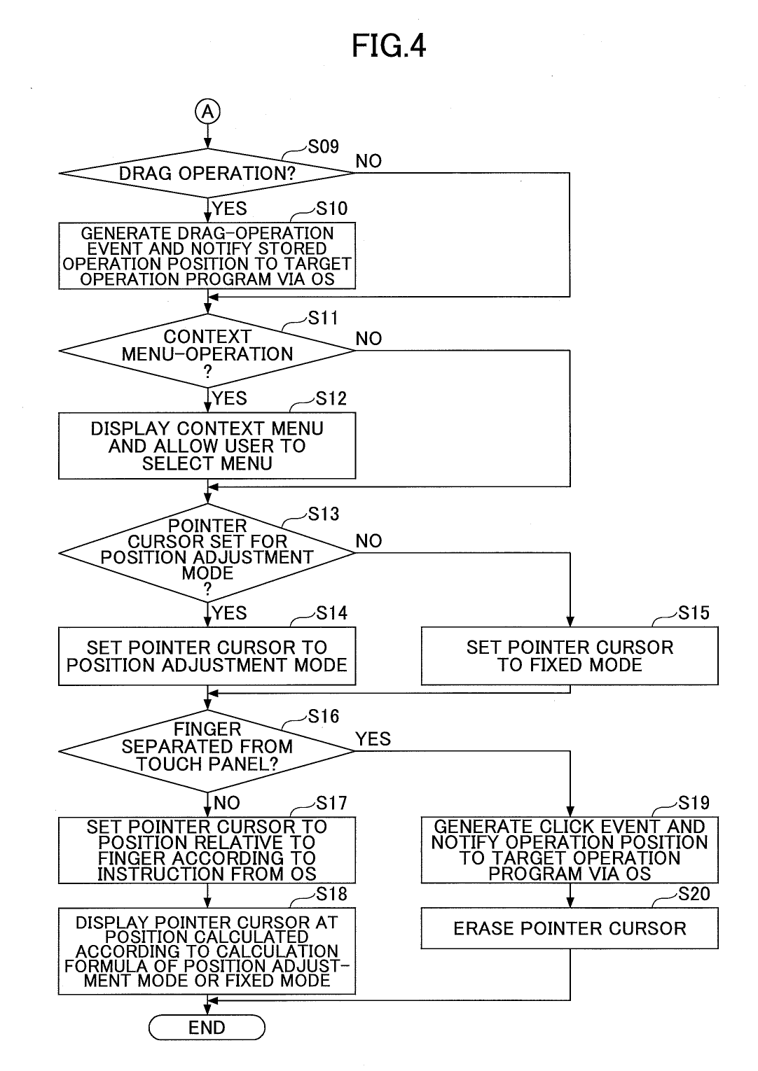

Next, an example of a process of the display process apparatus 10 according to an embodiment of the present invention is described by using a flowchart. FIGS. 3 and 4 illustrate an example of the flowchart of the processes performed by the display process apparatus 10.

In FIGS. 3 and 4, the touch detection unit 12 of the display process apparatus 10 detects a touch operation performed on the touch panel 11 by the user (Step S01). Then, the position identification unit 13 of the display process apparatus 10 identifies a touch position (designated coordinates) in response to a touch operation by the user's finger (Step S02). Then, the position identification unit 13 notifies the identified touch position to an OS or the like executed by the control execution unit 14 (Step S03).

Then, the control execution unit 14 calculates the position at which the pointer cursor is to be displayed (pointer cursor display position) according to data pertaining to the touch position, and stores the calculated pointer cursor display position to be the newest (latest) operation position (Step S04). Further, the control execution unit 14 determines whether the touch operation is a click operation (Step S05). Note that the term “click operation” is an operation of designating coordinates by an input operation. For example, the click operation may be a tapping operation performed with the user's finger.

In a case where the control execution unit 14 determines that the touch operation is a click operation (Yes in Step S05), the control execution unit 14 generates a click event and notifies the stored operation position to a target operation program via the OS (Step S06).

In a case where the touch operation is not a click operation (No in Step S05) or after the process of Step S06 is executed, the control execution unit 14 determines whether the touch operation is a double-click operation (Step S07). In a case where the touch operation is a double-click operation (Yes in Step S07), the control execution unit 14 generates a double-click event and notifies the stored operation position to the target operation program via the OS (Step S08).

In a case where the touch operation is not a double-click operation (No in Step S07) or after the process of Step S07 is executed, the control execution unit 14 determines whether the touch operation is a drag operation (Step S09). In a case where the touch operation is a drag operation (Yes in Step S09), the control execution unit 14 generates a drag event and notifies the range of the touch operation (operation range) to the target operation program via the OS (Step S10).

In a case where the touch operation is not a drag operation (No in Step S09) or after the process of Step S09 is executed, the control execution unit 14 determines whether the touch operation is a context menu operation (Step S11). In this embodiment, the “context menu operation” is an operation performed on an a context menu displayed on the screen by operating an icon or the like. In a case where the touch operation is a context menu operation (Yes in Step S11), the control execution unit 14 displays a context menu to allow the user to select menu (Step S12).

In a case where the touch operation is not a context menu operation (No in Step S11) or after the process of Step S12 is executed, the control execution unit 14 determines whether the pointer cursor is set to a position adjustment mode (Step S13). Note that the determination of the setting of the position adjustment mode may be set according to, for example, an application that is being executed. Alternatively, the user may be the set the determination of the setting of the position adjustment mode.

In a case where the pointer cursor is set to a position adjustment mode (Yes in Step S13), the control execution unit 14 sets the cursor pointer to be the position adjustment mode (Step S14). In a case where the pointer cursor is not set to a position adjustment mode (No in Step S13), the control execution unit 14 sets the cursor pointer to a fixed mode (Step S15). Detailed examples of the position adjustment mode and the fixed mode are described below. The point position adjustment unit 15 adjusts the position of the pointer cursor according to the position adjustment mode of Step S14 and the fixed mode of Step S15.

Then, the control execution unit 14 determines whether the user's finger has separated from the touch panel 11 (Step S16). In a case where the user's finger has not separated from the touch panel 11 (No in Step S16), the display control unit 16 sets the pointer cursor to a position relative to the finger (relative position) according to an instruction from the OS (Step S17). Then, the display control unit 16 displays the pointer cursor in a calculated position within a display area of the screen (Step S18). Note that the position at which the pointer cursor is to be displayed is calculated by the point position adjustment unit 15 based on a calculation formula of the position adjustment mode or the fixed mode.

In a case where the user's finger has separated from the touch panel 11 (Yes in Step S16), the control execution unit 14 generates a click event and notifies the operation position to the target operation program via the OS (Step S19). Further, the display control unit 16 erases the pointer cursor displayed on the screen of the screen display unit 17 (Step S20).

Note that the order for executing the determination processes in Steps S05, S07, S09, and S11 is not limited to the order described in this embodiment. Thus, the order for executing the determination processes may be arbitrarily changed.

### <Detailed Example of Display Control Process of Pointer Cursor>

Next, a detailed example of a display control process of a pointer cursor is described. When the user's finger touches the touch panel 11, the touch detection unit 12 detects the position in the touch panel touched by the user (touch position). The touch detection unit 12 notifies the touch position to the OS (control execution unit 14). The control execution unit 14 executes a touch process (e.g., click, double-click, drag operation, context-menu display) according to circumstance based on the touch position obtained from the position identification unit 13. Further, the control execution unit 14 calculates the position for displaying the pointer cursor (pointer cursor display position) based on the touch position obtained from the position identification unit 13. The display control unit 16 displays the pointer cursor in a position instructed from the OS.

In this embodiment, the display control unit 16 displays the pointer cursor when a finger touches the touch panel 11. The pointer cursor is displayed in a predetermined position (second point) based on a predetermined point located at an edge part of the display area. That is, the predetermined point is located at an edge of a given side of the display area. The predetermined position (second point) is located on a line (half-straight line) that extends from the predetermined point, connects the predetermined point and the touch position (first point), and continues to further extend a few points (e.g., few centimeters) apart from the touch position (first point). In this embodiment, the point of a target operation is not the touch position on the screen but is a position (coordinates) designated by the pointer cursor.

In a case where the touch position of the user's finger is assumed to be the point of a target operation as in a conventional example, the user cannot precisely recognize the point being touched because the point is hidden by the user's finger. Therefore, the user can only designate an approximate area in a display. Thus, in this embodiment, the pointer cursor of a target operation is displayed at a precise area distanced from the user's finger. Thereby, the user can visually confirm the position of the pointer cursor while precisely adjusting the position of the pointer cursor in real-time.

### <Detailed Example of Display Mode of Pointer Cursor>

Next, a detailed example of the display mode of the pointer cursor is described. In this embodiment, there are two types of methods for displaying the pointer cursor according to the touch position in the screen by way of a finger or a stylus. One type is the position adjustment mode and the second type is the fixed mode. However, the present invention is neither limited to the use of these types of modes nor limited to using two modes. In this embodiment, the switching of modes is performed according to an application or the like that is being executed by the OS.

In a case where the position adjustment mode is used, the angle and distance at which the pointer cursor is displayed relative to the finger are automatically changed according to the finger's position in the entire touch panel 11. Further, in the position adjustment mode, the direction in which the pointer cursor is oriented in a direction toward an edge of the screen, so that the pointer cursor is prevented from becoming a blind spot of an operation. Even in a case where the position of the finger is consecutively shifted, the angle and the distance of the pointer cursor relative to the finger are smoothly updated and do not abruptly change (jump).

On the other hand, in a case where the fixed mode is used, the distance at which the pointer cursor is displayed relative to the finger is automatically changed according to the finger's position in the entire touch panel 11. That is, in the fixed mode, the angle at which the pointer cursor is displayed relative to the finger is fixed and does not change.

The distance from the pointer cursor to the finger in each of the modes is a predetermined length designated by the user. For example, the user can quickly designate a wide area with minimal finger movement in the case where the position adjustment mode is used whereas the user can easily designate a precise point in the case where the fixed mode is used. Accordingly, in a case of performing a regular operation on a menu, button, or the like, the use of the position adjustment mode is convenient. In the position adjustment mode, the angle in which the pointer cursor is displayed relative to the finger is automatically adjusted. Further, the use of the fixed mode is preferable in a case where the pointer cursor is moved in straight linear directions or in a case where the pointer cursor is to be precisely moved (e.g., a case of using graphic software or Computer Aided Design (CAD) software).

Next, embodiments of displaying the pointer cursor by using the position adjustment mode and the fixed mode are described with reference to the drawings.

### First Embodiment

### Position Adjustment Mode

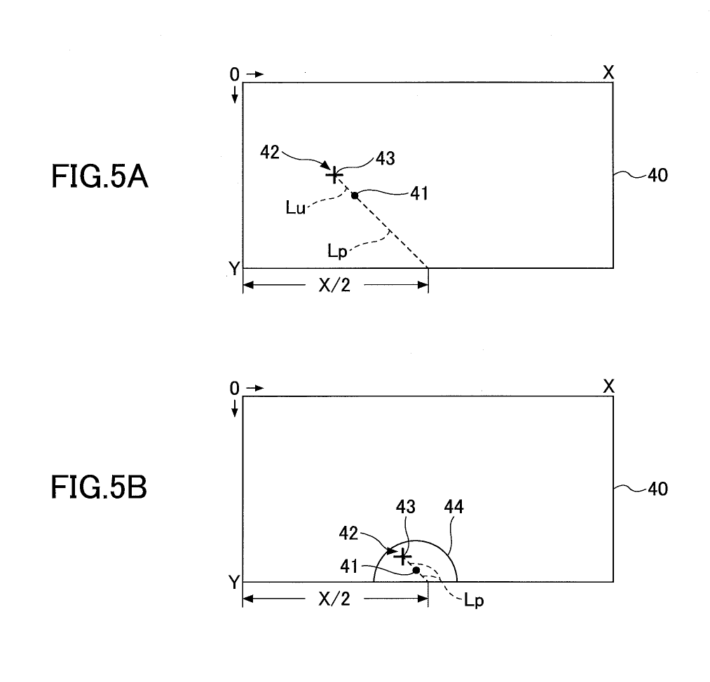

FIGS. 5A and 5B are schematic diagrams illustrating examples of displaying the pointer cursor by using the position adjustment mode according to the first embodiment. For the sake of explanation, X-Y coordinate axes in the examples of FIGS. 5A and 5B are illustrated in a case where an upper left corner of the screen 40 of the display process apparatus 10 is set to be a origin point (0, 0). In the examples of FIGS. 5A and 5B, the touch position 41 is illustrated as a dot whereas the pointer cursor 42 is illustrated as a cross. The foregoing description regarding the examples of FIGS. 5A and 5B also applies to the embodiments described below.

In the position adjustment mode according to the first embodiment, the position at which the pointer cursor is displayed is adjusted in a state where a lower edge center of the screen or an upper edge center of the screen is set as the predetermined point (reference point). In the position adjustment mode of the first embodiment, the distance “Lp” from the touch position 41 to the lower edge center of the screen 40 is obtained by the following Expression (1). In this example, the position at which the pointer cursor is displayed is illustrated as (X cursor, Y cursor), the horizontal width of the screen is illustrated as “X”, the vertical width of the screen is illustrated as “Y”, and the touch position (first point) is illustrated as (x, y).

$$\begin{matrix}[ Expression ( 1 ) ] & \\ Lp = \sqrt{{( \frac{X}{2} - x )}^{2} + {( Y - y )}^{2}} & ( 1 )\end{matrix}$$

For example, the distance between the touch position (first point) 41 of a finger and a position of a pointer cursor (second point) 42 actually displayed on the screen is assumed to be “L”. The distance between the finger to the pointer cursor that is set by the user is assumed to be “Lu”. When “Lu≧Lp”, it is assumed that “L=Lu”. When “LP<L”, it is assumed that “L=Lp”. In this example, the position at which the pointer cursor is displayed (X cursor, Y cursor) is obtained by the following Expressions (2) and (3) with respect to a coordinate system in which the upper left corner of the screen is the reference point.

$$\begin{matrix}[ Expressions ( 2 ) and ( 3 ) ] & \\ Xcursor = x - \frac{L ( X - 2 x )}{\sqrt{4 {Y}^{2} - 8 yY + {X}^{2} - 4 xX + 4 {y}^{2} + 4 {x}^{2}}} & ( 2 ) \\ Ycursor = y - \frac{2 L ( Y - y )}{\sqrt{4 {Y}^{2} - 8 yY + {X}^{2} - 4 xX + 4 {y}^{2} + 4 {x}^{2}}} & ( 3 )\end{matrix}$$

By performing calculation using the expressions above, the angle and the distance for displaying the pointer cursor relative to the position touched by the user are automatically adjusted. For example, the pointer cursor 42 is displayed in a position that is located on a straight line that extends from the lower center of the screen 40, connects the lower center of the screen 40 and the touch position 41, and continues to further extend a predetermined distance apart from the touch position 41 as illustrated in FIGS. 5A and 5B.

In a case where the coordinates (Xa, Ya) of the reference point at which the pointers converge on the screen 40 (e.g., lower edge center of screen 40), the center point (X cursor, Y cursor) 43 of the pointer cursor 42 relative to the touch position 41 may be obtained by using the following expressions.

(x−Xa):(y−Ya)=Lx:Ly

Lu²=Lx²+Ly²

X cursor=x−Lx

Y cursor=y−Ly

The x-coordinate distance from the touch position 41 and the center point 43 of the pointer cursor 42 is indicated as “Lx”. The x-coordinate distance from the touch position 41 and the center point 43 of the pointer cursor 42 is indicated as “Ly”.

Note that, the area obtained by the above-described expressions cannot be pointed when the distance “Lp” is less than the distance “Lu”. For example, in the case where the touch position 42 is moved downward from the center area of the screen 40, the finger cannot be moved further downward when the finger reaches the lower edge center of the screen 40. Therefore, the pointer cursor 42 remains in a position separated at a distance “Lu” from the lower edge center of the screen 40. Similarly, in a case where the touch position 42 is moved diagonally downward from another area of the screen 40, the finger cannot be further downward when the finger reaches the lower edge center of the screen 40. Therefore, the pointer cursor 42 42 remains in a position separated from the touch position 41 at a distance “Lu” and cannot extend any further. That is, as illustrated in FIG. 5B, the user cannot point any position within a semicircle area 44 in which the radius of the semicircle area 44 is the distance “Lu” from the lower edge center of the screen 40.

Therefore, in the position adjustment mode of the first embodiment, the distance “Lp” between the reference point and the touch position is applied to be the distance from the touch position 41 of the finger and the position of the pointer cursor 42 when the touch position 41 is located within the semicircular area 44. Accordingly, in using the expression (2) and (3), the distance “L” is assumed to be “L=Lu” when “Lu≧Lp” whereas the distance “L” is assumed to be “L=Lp” when “Lp<Lu”.

This prevents being unable to identify a position relative to the position of the pointer cursor 42. Accordingly, as the touch position 41 becomes closer to the point of the lower edge center of the screen 40, the position of the pointer cursor 42 becomes closer to the finger. Further, when the user touches a point at the lower edge center of the screen 40, the position of the pointer cursor 42 overlaps with the touch position 41. Accordingly, there is no area in the screen 40 that cannot be pointed by the user.

The above-described processes are performed with the expressions (1) to (3) when “Lp<Lu”. In this case where the condition “Lp<Lu” is satisfied, the distance “Lp” is set to be the distance between the pointer cursor 42 and the touch position 41 of the finger.

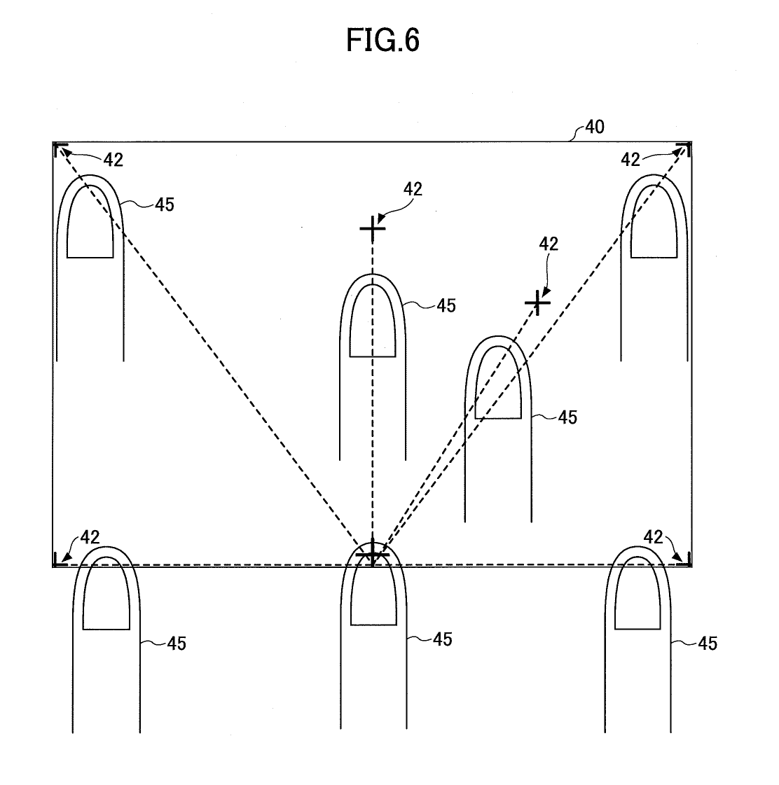

FIG. 6 is a schematic diagram for describing the pointer cursor display position in a case where a screen is touched with a finger. The dotted lines illustrated in FIG. 6 are depicted merely for purpose of describing the distance from the position of the lower edge center of the screen 40 (predetermined point) to the pointer cursor 42. The dotted lines are not actually displayed on the screen 40. In the example of FIG. 6, the touch position of a finger 45 and the reference point at the lower edge center are arranged on a single straight line (half-straight line).

In the position adjustment mode of the first embodiment, the pointer cursor 42 is automatically displayed in the upper part of the screen 40 when the user's finger (touch position) is positioned in the upper part of the screen 40 as illustrated in FIG. 6. Further, the pointer cursor 42 is automatically displayed in a diagonally upper left part of the screen 40 when the user's finger is positioned on the left side of the screen 40. Further, the pointer cursor 42 is automatically displayed in a diagonally upper right part of the screen 40 when the user's finger is positioned on the right side of the screen 40. Accordingly, substantially every part of the screen (display area) can be pointed by using the position adjustment mode of the first embodiment.

In the first embodiment, the pointer cursor 42 may become hidden under the finger 45 when the lower edge center of the screen 40 is touched by the finger. Thus, precise designation of a position may be difficult. Therefore, in a case where the user's finger 45 reaches the lower edge of the screen 40, the position of the pointer cursor 42 is obtained by using the following expressions (4) to (6) are used. In this example, the upper edge center of the screen 40 is set to be the reference point (predetermined point) with respect to a coordinate system in which the upper left corner of the screen 40 is the origin point.

$$\begin{matrix}[ Expressions ( 4 ) to ( 6 ) ] & \\ Lp = \sqrt{{( \frac{X}{2} - x )}^{2} + {y}^{2}} & ( 4 ) \\ Xcursor = x - \frac{L ( X - 2 x )}{\sqrt{{X}^{2} - 4 xX + 4 {y}^{2} + 4 {x}^{2}}} & ( 5 ) \\ Ycursor = y - \frac{2 Ly}{\sqrt{{X}^{2} - 4 xX + 4 {y}^{2} + 4 {x}^{2}}} & ( 6 )\end{matrix}$$

In the expressions (5) and (6), the distance “L” satisfies “L=Lu” when “Lu≧Lp” whereas the distance “L” satisfies “L=Lp” when “Lp<Lu”.

In a case where the finger 45 reaches the lower edge of the screen (not always the lower edge center), the expressions that are to be used are switched to from the expressions (1) to (3) to the expressions (4) to (6). Similarly, in a case where the finger 45 reaches the upper edge of the screen (not always the upper edge enter), the expressions that are to be used are switched from the expression (1) to (3) to the expressions (4) to (6).

A toggle type method is used to perform to the switching of expressions according to the upper edge of the screen 40 or the lower edge of the screen 40 illustrated in FIG. 6. That is, according to the first embodiment, the expressions (1) to (3) and the expression (4) to (6) are switched when the touch position reaches the upper end of the screen 40 or the lower end of the screen 40.

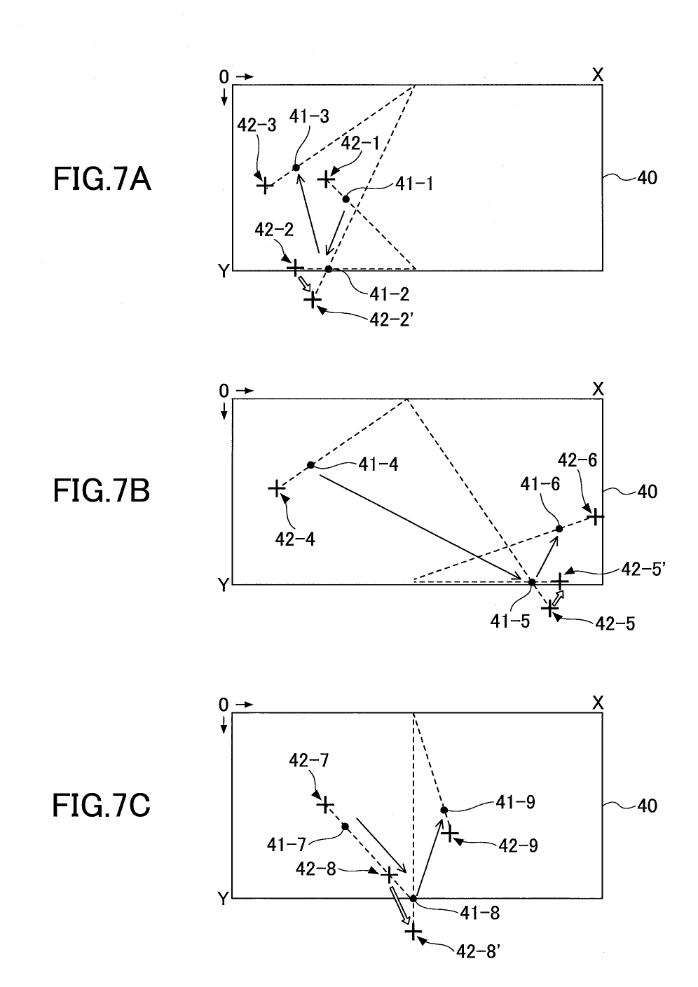

FIGS. 7A-7C are schematic diagrams illustrating examples in which the pointer cursor display position is switched according to the position adjustment mode of the first embodiment. The example of FIG. 7A depicts the setting of the display position of the pointer cursor 42 obtained by using the above-described expressions (e.g., expressions (1) to (3)) based on the lower edge center serving as the reference point. In the example of FIG. 7A, the finger of the user that is located on the touch position 41-1 of the screen 40 slides (moves) to the vicinity of the lower edge of the screen 40. When the user's finger reaches the touch position 41-2 at the lower edge of the screen 40, the reference point changes and the expressions (1) to (3) used for calculation switch to the expressions (4) to (6). Accordingly, the pointer cursor 42-2 jumps outside of the screen in a lower direction (pointer cursor 42-2′ in FIG. 7A). Note that the pointer cursor 42-2′ virtually jumps out of the screen 40. Thus, the jumping of the pointer cursor 42-2′ is not displayed on the screen 40. Therefore, the user can continue to operate on the screen 40 without being uneasy, experiencing discomfort, or losing track of the pointer cursor 42. Then, when the finger moves to the touch position 41-3 illustrated in FIG. 7A, the pointer cursor 42-3 is displayed at a position calculated by a corresponding expression based on the upper edge center serving as the reference point.

In the example of FIG. 7B, the user's finger located on the position of the pointer cursor 42-4 of FIG. 7B is moved toward the lower edge in a state contacting the screen 40. When the user's finger reaches the touch position 41-5 at the lower edge of the screen 40, the expressions (4) to (6) switch to the expressions (1) to (3), and the pointer cursor 42-5 jumps to the pointer cursor 42-5′. Accordingly, when the user's finger moves from the touch position 41-5 to the touch position 41-6, the pointer cursor 42-6 is displayed in a position calculated by a corresponding expression based on the lower edge center serving as the reference point.

FIG. 7C depicts an example of the switching of reference points and expressions when the user's finger is moved toward the lower edge center of the screen 40. In the example of FIG. 7C, the user's finger located at the touch position 41-7 slides to the vicinity of the lower edge center while maintaining contact to the screen 40. When the user's finger reaches the lower edge center (touch position 41-8), the currently set expressions (1) to (3) switch to the expressions (4) to (6), and the pointer cursor display position changes to a position where the upper edge center is the reference point. Accordingly, the pointer cursor 42-8 jumps to the pointer cursor 42-8′. The pointer cursor 42-8′ virtually jumps out of the screen 40. Thus, the jumping of the pointer cursor 42-8′ is not displayed on the screen 40. Therefore, the user can continue to operate on the screen 40 without being uneasy. Then, when the finger moves from the touch position 41-8 to the touch position 41-9, the pointer cursor 42-9 is displayed at a position calculated by a corresponding expression based on the upper edge center serving as the reference point.

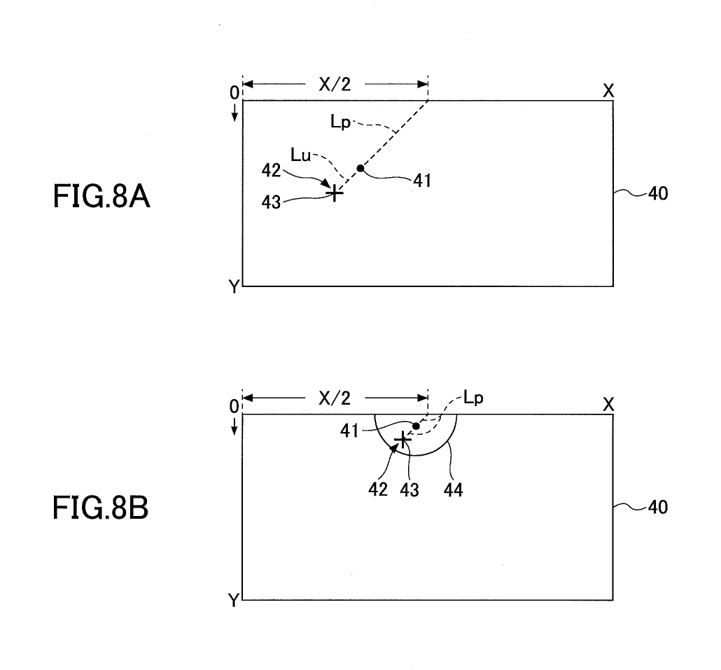

FIGS. 8A and 8B are schematic diagrams illustrating examples of displaying the pointer cursor in a case where the upper edge center of the screen is set as the reference point. As illustrated in FIGS. 8A and 8B, the center point 43 of the pointer cursor 42 is calculated by using the expressions (4) to (6) in a case where the upper edge center of the screen 40 is set to be the reference point (predetermined point). The pointer cursor 42 is displayed at the coordinates obtained by the calculation.

In the case where the upper edge center of the screen 40 is the reference point, the pointer cursor 42 is displayed lower (on the near side) than the user's finger as illustrated in FIGS. 8A and 8B. This manner of displaying the pointer cursor 42 is effective in a case where, for example, the user desires to point a position in the vicinity of the lower edge of the screen 40.

As illustrated in FIG. 8B, the distance “Lp” between the reference point and the touch position 41 is used as the distance between the touch position 41 and the pointer cursor 42 when the touch position 41 enters the area 44 having a predetermined radius “Lu”. Accordingly, the distance between the touch position 41 and the pointer cursor 42 becomes relatively shorter as the distance between the touch position 41 and the upper edge center of the screen 40 becomes shorter. Accordingly, the position of the pointer cursor and the touch position overlap when the user's finger touches the point of the upper edge of the screen 40. Thus, the there is no area in the screen 40 that cannot be pointed with the pointer cursor 42.

In some cases, the pointer cursor 42 may be hidden beneath the user's finger at the vicinity of the upper edge center of the screen 40 such that precise designation may become difficult. Accordingly, the reference point is changed from the upper edge center to the lower edge center and the expressions (4) to (6) are switched to the expressions (1) to (3).

In the position adjustment mode according to the first embodiment, the expressions (1) to (3) to the expressions (4) to (6) are switched when the touch position 41 is moved to the lower edge of the screen 40 or the upper edge of the screen 40. That is, in the position adjustment mode according to the first embodiment, the switching of expressions based on the upper or lower edge of the screen 40 is performed according to a toggle type method.

Hence, in the position adjustment mode according to the first embodiment, the center point of the pointer cursor 42 is calculated by switching the reference point and the expressions (switching between expressions (1) to (3) and expressions (4) to (6)) corresponding to the reference point. Accordingly, operation can be performed without a blind spot in the screen 40. Thus, a position in the entire screen 40 can be easily designated.

### Second Embodiment

### Position Adjustment Mode

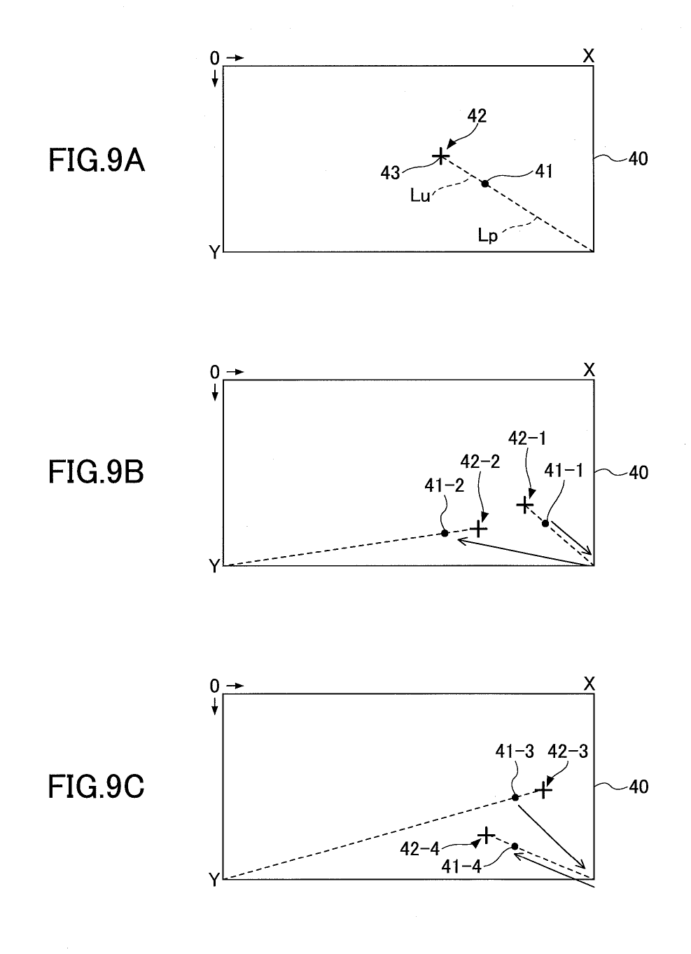

In the position adjustment mode according to the second embodiment, the pointer cursor display position is adjusted based on a corner of a screen. FIGS. 9A-9C illustrate examples of displaying a pointer cursor in a position adjustment mode according to the second embodiment. For example, the point adjustment unit 15 is assumed to currently set the position of the pointer cursor by using the expressions (1) to (3) of the first embodiment. In this current state, the point adjustment unit 15 assumes that the lower right corner of the screen 40 is the reference point (predetermined point) at which the pointer cursor(s) 42 converges when the touch position reaches the lower right corner of the screen 40 as illustrated in FIG. 9A. Accordingly, the point adjustment unit 15 switches the expressions (1) to (3) to the following expressions (7) to (9) with respect to a coordinate system having the upper left corner as the origin point, and calculates the center point 43 of the pointer cursor 42 by using the expressions (7) to (9).

$$\begin{matrix}[ Expressions ( 7 ) to ( 9 ) ] & \\ Lp = \sqrt{{( X - x )}^{2} + {( Y - y )}^{2}} & ( 7 ) \\ Xcursor = x - \frac{L ( X - x )}{\sqrt{{Y}^{2} - 2 yY + {X}^{2} - 2 xX + {y}^{2} + {x}^{2}}} & ( 8 ) \\ Ycursor = y - \frac{L ( Y - y )}{\sqrt{{Y}^{2} - 2 yY + {X}^{2} - 2 xX + {y}^{2} + {x}^{2}}} & ( 9 )\end{matrix}$$

In the expressions (8) and (9), the distance “L” is assumed to be “L=Lu” when “Lu≧Lp” whereas the distance “L” is assumed to be “L=Lp” when “Lp<Lu”.

Similar to the first embodiment, the distance “Lp” between the reference point and the touch position 41 is used as the distance between the touch position 41 and the pointer cursor 42 when the touch position 41 enters an area having the reference point as its center and having a predetermined radius of “Lu”.

Further, the point position adjustment unit 15 switches the expressions (7) to (9) to the following expressions (10) to (12) with respect to a coordinate system having the upper left corner as the origin point when the touch position 41 reaches the lower right corner of the screen 40, and calculates the center point 43 of the pointer cursor 42.

$$\begin{matrix}[ Expressions ( 10 ) to ( 12 ) ] & \\ Lp = \sqrt{{x}^{2} + {( Y - y )}^{2}} & ( 10 ) \\ Xcursor = x - \frac{- Lx}{\sqrt{{Y}^{2} - 2 yY + {y}^{2} + {x}^{2}}} & ( 11 ) \\ Ycursor = y - \frac{L ( Y - y )}{\sqrt{{Y}^{2} - 2 yY + {y}^{2} + {x}^{2}}} & ( 12 )\end{matrix}$$

In the expressions (11) and (12), the distance “L” is assumed to be “L=Lu” when “Lu≧Lp” whereas the distance “L” is assumed to be “L=Lp” when “Lp<Lu”.

In the position adjustment mode according to the second embodiment, the switching of expressions is performed according to a toggle type method. When the touch position 41 reaches a corner of the screen 40, the expressions (7) to (9) are sequentially switched to the expressions (10) to (12).

FIG. 9B depicts an example of the switching of expressions when the user's finger is moved toward the lower right corner of the screen 40. In the example of FIG. 9B, when the user's finger touches the screen 40, the expressions (7) to (9) are applied to the touch position 41-1 where the lower right corner of the screen 40 is the reference point (predetermined point). Accordingly, the pointer cursor 42-1 is displayed at the position calculated with the expressions (7) to (9). When the user's finger slides from the touch position 41-1 to the lower right corner of the screen 40, the point position adjustment unit 15 switches the currently used expressions (7) to (9) to the expressions (10) to (12), so that the center point 43 of the pointer cursor 42 is calculated. As a result, when the finger slides from the lower right corner of the screen 40 to the touch position 41-2 as illustrated in FIG. 9B, the pointer cursor 42-2 is displayed at a position calculated by a corresponding expression based on the lower left corner of the screen 40 serving as the reference point.

Further, as illustrated in FIG. 9C, when the finger slides from the touch position 41-3 to the lower right corner of the screen 40, the point position adjustment unit 15 switches the currently used expressions (10) to (12) to the expressions (7) to (9), so that the center point 43 of the pointer cursor 42 is calculated. As a result, when the finger slides from the lower right corner of the screen 40 to the touch position 41-4 as illustrated in FIG. 9C, the pointer cursor 42-4 is displayed at a position calculated by a corresponding expression based on the lower right corner of the screen 40 serving as the reference point.

In the position adjustment mode according to the second embodiment, the switching of reference points (predetermined points) not only can be performed when the touch position reaches the lower right corner of the screen or the lower left corner of the screen but can also be performed when the touch position reaches the upper right corner of the screen or the upper left corner of the screen.

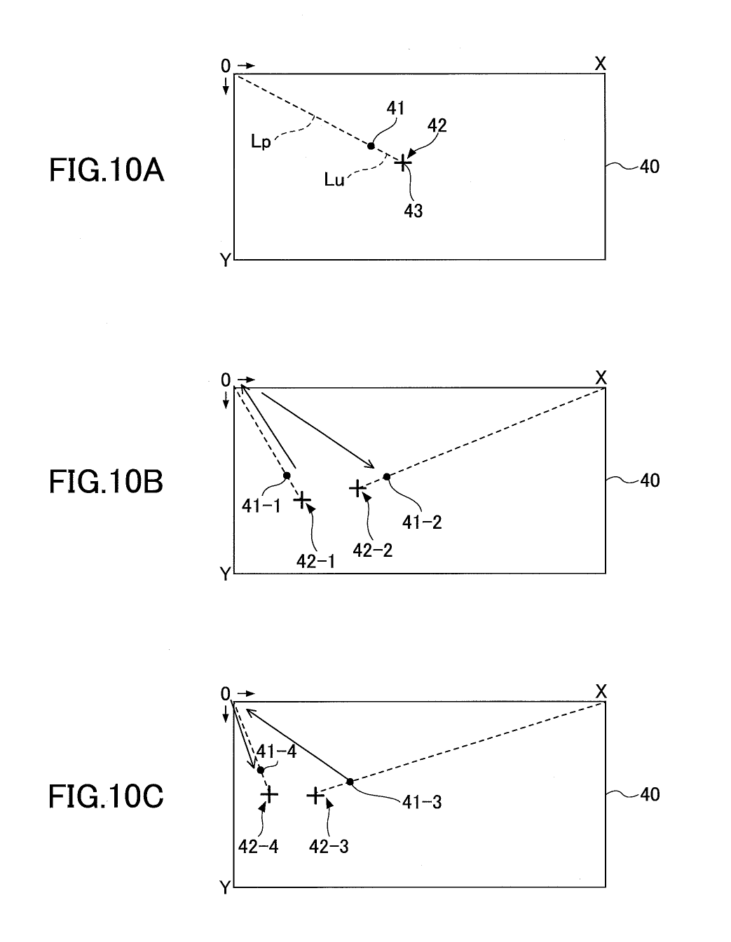

FIGS. 10A to 10C illustrate examples of displaying the pointer cursor based on the upper left corner of the screen serving as the reference point. For example, the point position adjustment unit 15 is assumed to currently set the position of the pointer cursor by using the expressions (1) to (3) of the first embodiment. In this current state, when the touch position reaches a corner of the screen 40, the point adjustment unit 15 switches the expressions (1) to (3) to the following expressions (13) to (15) with respect to a coordinate system having the upper left corner as the origin point, and calculates the center point 43 of the pointer cursor 42 by using the expressions (13) to (15).

$$\begin{matrix}[ Expressions ( 13 ) to ( 15 ) ] & \\ Lp = \sqrt{{x}^{2} + {y}^{2}} & ( 13 ) \\ Xcursor = x - \frac{- Lx}{\sqrt{{y}^{2} + {x}^{2}}} & ( 14 ) \\ Ycursor = y - \frac{- Ly}{\sqrt{{y}^{2} + {x}^{2}}} & ( 15 )\end{matrix}$$

In the expressions (14) and (15), the distance “L” is assumed to be “L=Lu” when “Lu≧Lp” whereas the distance “L” is assumed to be “L=Lp” when “Lp<Lu”.

Similar to the first embodiment, the distance “Lp” between the reference point and the touch position 41 is used as the distance between the touch position 41 and the pointer cursor 42 when the touch position 41 enters an area having the reference point of the upper left corner of the screen 40 as its center and having a predetermined radius of “Lu”.

Further, the point position adjustment unit 15 switches the expressions (13) to (15) to the following expressions (16) to (18) when the touch position 41 reaches the upper left corner of the screen 40, and calculates the center point 43 of the pointer cursor 42.

$$\begin{matrix}[ Examples ( 16 ) to ( 18 ) ] & \\ Lp = \sqrt{{( x - X )}^{2} + {y}^{2 }} & ( 16 ) \\ Xcursor = x - \frac{L ( X - x )}{\sqrt{{X}^{2} - 2 xX + {y}^{2} + {x}^{2}}} & ( 17 ) \\ Ycursor = y - \frac{- Ly}{\sqrt{{X}^{2} - 2 xX + {y}^{2} + {x}^{2}}} & ( 18 )\end{matrix}$$

In the expressions (17) and (18), the distance “L” is assumed to be “L=Lu” when “Lu≧Lp” whereas the distance “L” is assumed to be “L=Lp” when “Lp<Lu”.

In the position adjustment mode according to the second embodiment, the switching of expressions is performed according to a toggle type method. When the touch position 41 reaches a corner of the screen 40, the expressions (13) to (15) are sequentially switched to the expressions (16) to (18).

FIG. 10B depicts an example of the switching of expressions when the user's finger is moved toward the upper left corner of the screen 40. In the example of FIG. 10B, when the user's finger touches the screen 40, the expressions (13) to (15) are applied to the touch position 41-1 where the upper left corner of the screen 40 is the reference point. Accordingly, the pointer cursor 42-1 is displayed at the position calculated with the expressions (13) to (15). When the user's finger slides from the touch position 41-1 to the upper left corner of the screen 40, the point position adjustment unit 15 switches the currently used expressions (13) to (15) to the expressions (16) to (18), so that the center point 43 of the pointer cursor 42 is calculated. As a result, when the finger moves from the upper left corner of the screen 40 to the touch position 41-2 as illustrated in FIG. 10B, the pointer cursor 42-2 is displayed at a position calculated by a corresponding expression based on the upper right corner of the screen 40 serving as the reference point.

Further, as illustrated in FIG. 10C, when the finger slides from the touch position 41-3 to the upper left corner of the screen 40, the point position adjustment unit 15 switches the currently used expressions (16) to (18) to the expressions (12) to (15), so that the center point 43 of the pointer cursor 42 is calculated. Accordingly, the pointer cursor 42-4 is displayed at the lower right of the finger relative to the touch position 41-4.

In the above-described examples, the expressions are switched according to the toggle method in which the expressions are switched whenever the touch position 41 moves to the upper left corner of the screen 40. However, the method for switching the expressions are limited to the above-described examples. For example, the expressions may be switched whenever the touch position 41 is moved to the upper right corner of the screen 40. Further, in the position adjustment mode according to the second embodiment, the expressions may be switched based on a switching order that is set beforehand according to all corners of the screen 40.

### Third Embodiment

### Position Adjustment Mode

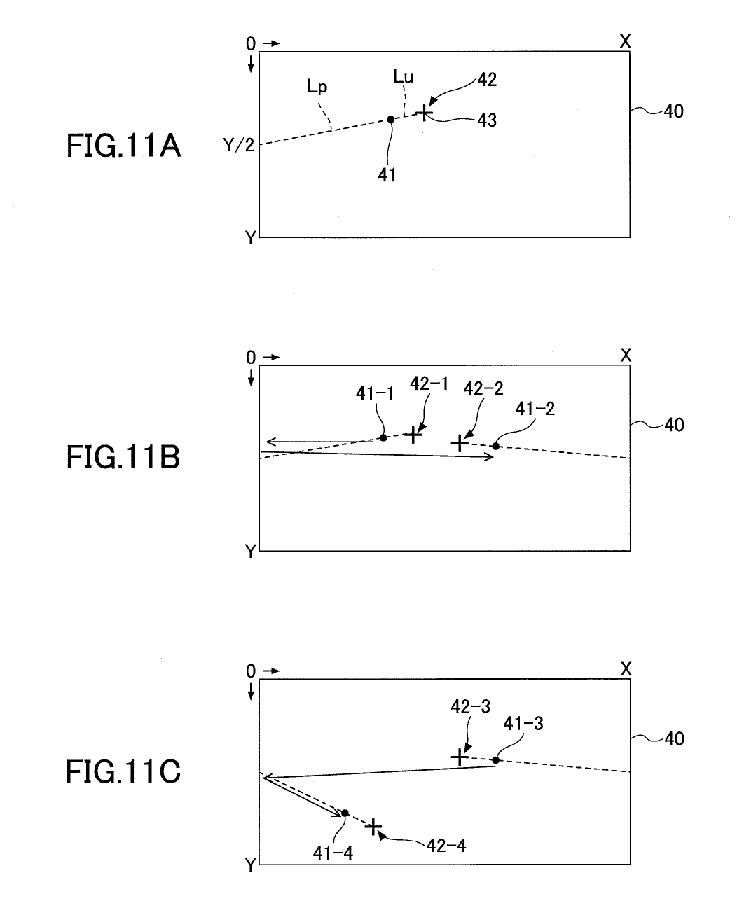

In the position adjustment mode according to the third embodiment, the pointer cursor display position is adjusted based on a left edge center of a screen or a right edge center of the screen. FIGS. 11A-11C illustrate examples of displaying a pointer cursor in a position adjustment mode according to the third embodiment. For example, the point adjustment unit 15 is assumed to currently set the position of the pointer cursor by using the expressions (1) to (3) of the first embodiment. In this current state, the point adjustment unit 15 assumes that the left edge center of the screen 40 is the reference point (predetermined point) at which the pointer cursor (s) 42 converges when the touch position 41 reaches the left edge of the screen 40 as illustrated in FIG. 11A. Accordingly, the point adjustment unit 15 switches the expressions (1) to (3) to the following expressions (19) to (21) and calculates the center point 43 of the pointer cursor 42 by using the expressions (19) to (21).

$$\begin{matrix}[ Expressions ( 19 ) to ( 21 ) ] & \\ Lp = \sqrt{{x}^{2} + {( y - \frac{Y}{2} )}^{2}} & ( 19 ) \\ Xcursor = x - \frac{- 2 Lx}{\sqrt{{Y}^{2} - 4 yY + 4 {y}^{2} + 4 {x}^{2}}} & ( 20 ) \\ Ycursor = y - \frac{L ( Y - 2 y )}{\sqrt{{Y}^{2} - 4 yY + 4 {y}^{2} + 4 {x}^{2}}} & ( 21 )\end{matrix}$$

In the expressions (20) and (21), the distance “L” is assumed to be “L=Lu” when “Lu≧Lp” whereas the distance “L” is assumed to be “L=Lp” when “Lp<Lu”.

In the example of FIG. 11A, the distance “Lp” between the reference point and the touch position 41 is used as the distance between the touch position 41 and the pointer cursor 42 when the touch position 41 enters an area having the left edge center of the screen 40 as its center and having a predetermined radius of “Lu”.

Further, when the touch position 41 reaches the left edge of the screen 40, the point position adjustment unit 15 switches the expressions (19) to (21) to the following expressions (22) to (24) based on the right edge center of the screen serving as a reference point with respect to a coordinate system having the upper left corner as the origin point, and calculates the center point 43 of the pointer cursor 42.

$$\begin{matrix}[ Examples ( 22 ) to ( 24 ) ] & \\ Lp = \sqrt{{( x - X )}^{2} + {( y - \frac{Y}{2} )}^{2}} & ( 22 ) \\ Xcursor = x - \frac{2 L ( X - x )}{\sqrt{{Y}^{2} - 4 yY + 4 {X}^{2} - 8 xX + 4 {y}^{2} + 4 {x}^{2}}} & ( 23 ) \\ Ycursor = y - \frac{L ( Y - 2 y )}{\sqrt{{Y}^{2} - 4 yY + 4 {X}^{2} - 8 xX + 4 {y}^{2} + 4 {x}^{2}}} & ( 24 )\end{matrix}$$

In the expressions (23) and (24), the distance “L” is assumed to be “L=Lu” when “Lu≧Lp” whereas the distance “L” is assumed to be “L=Lp” when “Lp<Lu”. In the position adjustment mode according to the third embodiment, the switching of expressions is performed according to a toggle type method. When the touch position 41 reaches a left edge or right edge of the screen 40, the expressions (19) to (21) are sequentially switched to the expressions (22) to (24).

In the example of FIG. 11B, when the user's finger touches the screen 40, the expressions (19) to (21) are applied to the touch position 41-1 where the left edge center of the screen 40 is the reference point (predetermined point). Accordingly, the pointer cursor 42-1 is displayed at the position calculated with the expressions (19) to (21). When the user's finger slides from the touch position 41-1 to the left edge of the screen 40, the point position adjustment unit 15 switches the currently used expressions (19) to (21) to the expressions (22) to (24), so that the center point 43 of the pointer cursor 42 is calculated. Accordingly, when the finger slides from the left edge of the screen 40 to the touch position 41-2 as illustrated in FIG. 11B, the pointer cursor 42-2 is displayed at a position calculated by a corresponding expression based on the right edge center of the screen 40 serving as the reference point.

Further, as illustrated in FIG. 11C, when the finger slides from the touch position 41-3 to the left edge of the screen 40, the point position adjustment unit 15 switches the currently used expressions (22) to (24) to the expressions (19) to (21), so that the center point 43 of the pointer cursor 42 is calculated. Accordingly, the pointer cursor 42-4 is displayed on the left side of the finger relative to the touch position as illustrated in FIG. 11C.

In the above-described examples, the expressions are switched according to the toggle method in which the expressions are switched whenever the touch position 41 moves to the left edge of the screen 40. However, the method for switching the expressions are limited to the above-described examples. For example, the expressions may be switched whenever the touch position 41 is moved to the right edge of the screen 40. Further, in the third embodiment, the expressions may be switched by using both the left and right edges of the screen 40.

The position adjustment mode of any one of the above-described embodiments (first to third embodiments) may be partly or entirely combined with the position adjustment mode of another one or more of the above-described embodiments. Accordingly, in a case of using the position adjustment mode, the point position adjustment unit 15 can control the switching of the pointer cursor displayed on the screen 40 in which the above-described edge part (e.g., upper edge center, lower edge center, corner, left edge center, and right edge center) of the screen 40 serves as the reference point. Accordingly, operation can be performed without a blind spot in the screen 40 and without an area that is difficult to designate. Thus, a position in the entire screen 40 can be easily designated.

Note that the setting of the above-described reference points is not limited to the settings described above. For example, the position of the reference point does not need to be set at the center relative to the upper edge, the lower edge, the left edge, and the right edge. For example, the position of the reference point may be set to be an area that is more closer to one side (i.e., not the center) of the upper edge, the lower edge, the left edge, and the right edge. Further, the setting of the reference point may be displayed according to, for example, an application displayed on a screen. Alternatively, the reference point may be arbitrarily set according to the settings by the user.

### <Fixed Mode>

The position adjustment mode can cover a broad range in the display area of a screen by a small amount of finger movement because the pointer cursor moves in a manner circling the periphery of a finger where the reference point serves as the center. Therefore, in a case of using, for example, drawing software to perform drawing, the angle of the pointer cursor relative to the finger is preferred to be fixed, so that the positions of fine dots can be easily designated. Accordingly, the control execution unit 14 switches the position adjustment mode to the fixed mode according to, for example, the application to be executed. For example, the control execution unit 14 switches the position adjustment mode to the fixed mode in a case where fine dots are to be designated. Note that the control execution unit 14 may perform a control to return the fixed mode to an initial mode, for example, in a case where the execution of the application is completed or a case where the application is switched to another application. Next, embodiments of displaying a pointer cursor in the fixed mode are described with reference to the drawings.

### First Embodiment

### Fixed Mode

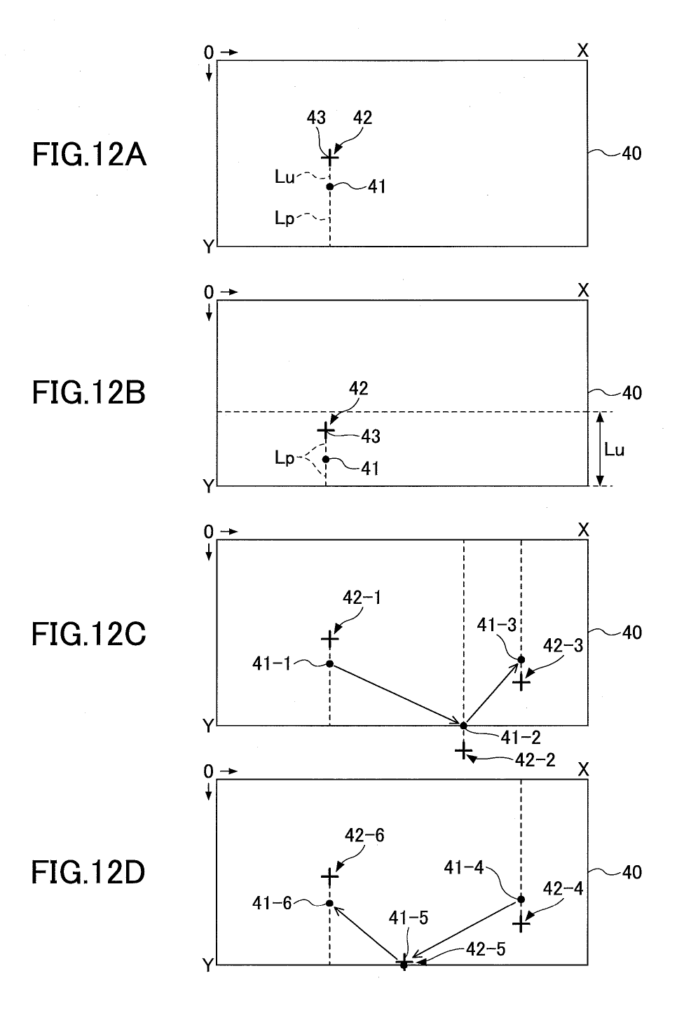

FIGS. 12A-12D are schematic diagrams illustrating examples of displaying a pointer cursor in a fixed mode according to the first embodiment. In the fixed mode of the first embodiment, the position at which the pointer cursor 42 is displayed (second point) is calculated by using a predetermined expression(s). The second point is calculated according to the touch position 41 (first point) in a case where the lower edge of the screen 40 serves as the reference point (predetermined point). For example, the center point 43 of the pointer cursor 42 is calculated by using the following expressions (25) to (26) with respect to a coordinate system having an upper left corner of the screen 40 serving as an origin point.

[Expressions (25) to (27)]

Lp=Y−y (25)

X cursor=x (26)

Y cursor=y−L (27)

In the expression (27), the distance “L” is assumed to be “L=Lu” when “Lu≧Lp” whereas the distance “L” is assumed to be “L=Lp” when “Lp<Lu”.

In the example of FIG. 12A, the cursor pointer 42 is displayed in a target area situated within a display area of the screen 40 and positioned on a half-straight line perpendicularly extending toward the touch position from the lower edge part of the screen 40. The pointer cursor 42 has a center point 43 that is located a predetermined distance Lu from the touch position 41. The distance from the touch position 41 to the lower edge of the screen 40 is indicated as “Lp”. In the fixed mode, the relative relationship between the touch position 41 and the center point 43 of the pointer cursor 42 is basically fixed. In a case where the fixed mode is used, the reference point changes when the touch position 41 moves in an X-axis direction.

In a case where the touch position reaches the lower edge of the screen in the fixed mode, the pointer cursor cannot be displayed further lower than the touch position if the position of the pointer cursor is simply set to be located a predetermined distance Lu higher than the touch position. That is, the user is unable to designate an area located a predetermined distance Lu lower than the lower edge of the screen 40. Therefore, similar to the above-described position adjustment mode, in a case where the fixed mode according to the first embodiment is used, an area that cannot be pointed (designated) is eliminated by adjusting the value of the predetermined distance Lu when the touch position 41 enters an area that is located the predetermined distance Lu from the lower edge of the screen 40. For example, in a case where the touch position 41 is located in a position lower than the predetermined distance Lu from the lower edge of the screen 40 as illustrated in FIG. 12B, the distance Lu between the touch position 41 and the lower edge of the screen 40 is applied as the distance Lu between the touch position 41 and the pointer cursor 42. That is, in a case where the touch position 41 is located the predetermined distance Lu from the lower edge of the screen 40, the predetermined distance Lu is shortened to become equal to the distance Lp. Accordingly, even in a case where the user's finger is located the predetermined distance Lu from the lower edge of the screen 40, the user can designate the pointer cursor 42. Thereby, an area of the screen 40 that cannot be designated can be eliminated.

Further, similar to the position adjustment mode, in a case where the fixed mode according to the first embodiment is used, the reference point (predetermined point) is switched when the user's finger reaches the lower edge of the screen 40. For example, the point position adjustment unit 15 controls the reference point (predetermined point) by using the following expressions (28) to (30) with respect to a coordinate system having upper left corner of the screen 40 as an origin point. The reference point (predetermined point) is a point where a line vertically extending from the touch position 41 intersects the upper edge of the screen 40.

[Expressions (28) to (30)]

Lp=Y−y (28)

X cursor=x (29)

Y cursor=y+L (30)

In the expression (30), the distance “L” is assumed to be “L=Lu” when “Lu≧Lp” whereas the distance “L” is assumed to be “L=Lp” when “Lp<Lu”.

In the fixed mode according to the first embodiment, the switching of expressions that is performed when the touch position is moved to the lower edge of the screen 40 is performed according to a toggle type method. When the touch position 41 reaches the lower edge of the screen 40, the expressions (25) to (27) are sequentially switched to the expressions (28) to (30).

FIG. 12C depicts an example of switching expressions according to the touch position 41 relative to the lower edge of the screen 40. In the example of FIG. 12C, when the user's finger touches the screen 40, the expressions (25) to (27) are applied to the touch position 41-1 in which the reference point (predetermined point) is a point where a line perpendicularly extending from the touch point 41-1 intersects the lower edge of the screen 40. Accordingly, the pointer cursor 42-1 is displayed at the position calculated with the expressions (25) to (27).

When the user's finger slides from the touch position 41-1 to the lower edge of the screen 40 (touch position 41-2), the point position adjustment unit 15 switches the currently used expressions (25) to (27) to the expressions (28) to (30), so that the center point of the pointer cursor 42 is calculated. As a result, the position of the pointer cursor 42-2 is set in which the reference point is a point where a line perpendicularly extending from the touch point 41-2 intersects the upper edge side of the screen 40 as illustrated in FIG. 12C. Then, the pointer cursor 42-3 is displayed in the position illustrated in FIG. 12C when the user's finger slides from the touch position 41-2 to the touch position 41-3 in the screen 40.

Further, as illustrated in FIG. 12D, when the finger slides from the touch position 41-4 to the touch position 41-5, the point position adjustment unit 15 switches the currently used expressions (28) to (30) to the expressions (25) to (27), so that the center point of the pointer cursor 42 is calculated. As a result, the pointer cursor 42-5 is set as illustrated in FIG. 12D in which the reference point is the point where a line perpendicularly extending from the touch position 41-5 intersects the lower edge side of the screen 40. Then, when the user's finger slides from the touch position 41-5 to the touch position 41-6, the pointer cursor 42-6 is displayed in a position illustrated in FIG. 12D.

In the fixed mode according to the first embodiment, the switching of reference points and expressions not only can be performed when the touch position reaches the lower edge of the screen 40 but can also be performed when the touch position reaches the upper edge of the screen 40. Alternatively, the switching may be performed by using both the left and right edges of the screen 40.

### Second Embodiment

### Fixed Mode

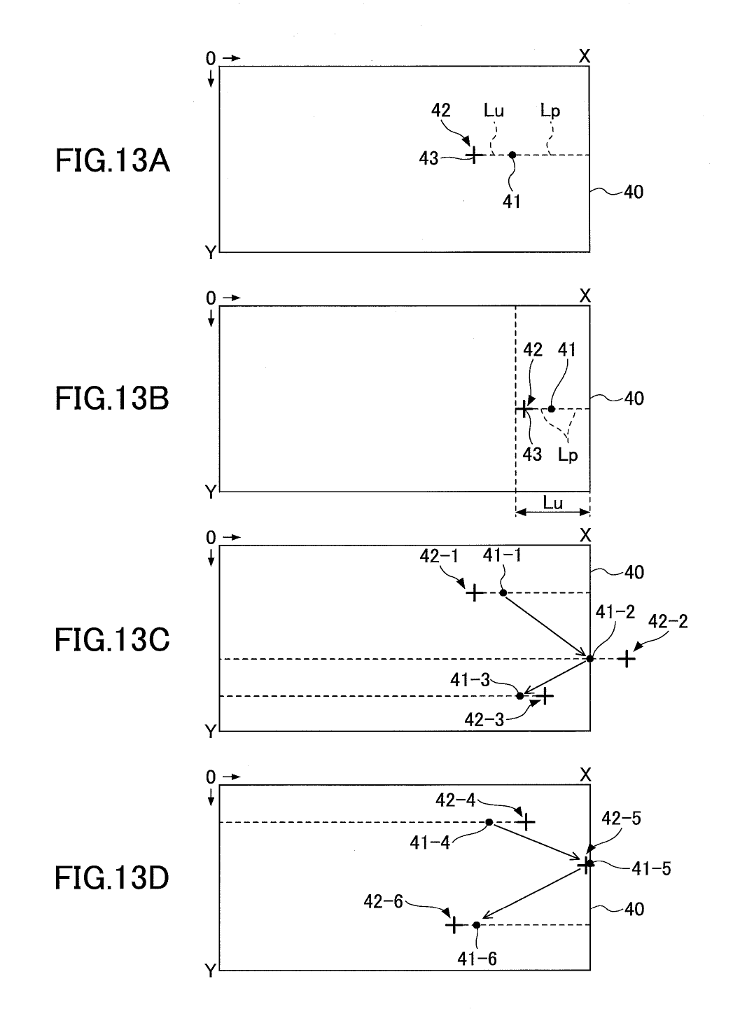

In the fixed mode according to the second embodiment, the position at which the pointer cursor is displayed is adjusted according to the right edge of the screen 40 or the left edge of the screen 40. FIGS. 13A-13D are schematic diagrams illustrating examples of displaying a pointer cursor in a fixed mode according to the second embodiment.

For example, when the user's finger reaches the right edge of the screen 40, the point adjustment unit 15 switches to the following expressions (31) to (33) with respect to a coordinate system having an upper left corner of the screen 40 serving as an origin point, and calculates the center of the pointer cursor 42.

[Expressions (31) to (33)]

Lp=X−x (31)

X cursor=x−L (32)

Y cursor=y (33)

In the expression (32), the distance “L” is assumed to be “L=Lu” when “Lu≧Lp” whereas the distance “L” is assumed to be “L=Lp” when “Lp<Lu”.

In the example of FIG. 13A, the distance from the right edge of the screen 40 to the touch position (x, y) 41 is assumed to be “Lp”, and the distance from the touch position 41 to the center point (X cursor, Y cursor) of the pointer cursor is assumed to be “Lu”.

In this example, the position of the pointer cursor 42 relative to the touch position 41 is calculated by using the expressions (31) to (33). Accordingly, the pointer cursor 42 is displayed at the calculated coordinates.

Similar to the fixed mode of the first embodiment, the distance between the touch position 41 and the pointer cursor 42 is set to be equal to the distance Lp from the touch position 41 to the right edge of the screen Lp in a case where the distance between the touch position 41 and the right edge of the screen 40 is less than the predetermined distance Lu (positioned to be closer to the right edge than the distance Lu) as illustrated in FIG. 13B.

Further, when the user's finger touches the right edge of the screen 40 in a case where the left edge of the screen 40 serves as the reference point, the expressions (31) to (33) are switched to the following expressions (34) to (36) with respect to a coordinate system having the upper left corner of the screen 40 serving as the origin point.

[Expressions (34) to (36)]

Lp=x (34)

X cursor=x+L (35)

Y cursor=y (36)

In the expression (35), the distance “L” is assumed to be “L=Lu” when “Lu≧Lp” whereas the distance “L” is assumed to be “L=Lp” when “Lp<Lu”.

In the fixed mode according to the second embodiment, the switching of expressions is performed according to a toggle type method. When the touch position 41 reaches the right edge of the screen 40, the expressions (31) to (33) are sequentially switched to the expressions (34) to (36).

FIG. 13C depicts an example of switching expressions according to the touch position 41 relative to the right edge of the screen 40. In the example of FIG. 13C, when the user's finger touches the screen 40, the expressions (31) to (33) are applied to the touch position 41-1 in which the reference point (predetermined point) is a point where a line perpendicularly extending from the touch point 41-1 intersects the right edge side of the screen 40. Accordingly, the pointer cursor 42-1 is displayed at the position calculated with the expressions (31) to (33).

When the user's finger slides from the touch position 41-1 to the right edge of the screen 40 (touch position 41-2), the point position adjustment unit 15 switches the currently used expressions (31) to (33) to the expressions (34) to (36), so that the center point of the pointer cursor 42 is calculated. As a result, the position of the pointer cursor 42-2 is set in which the reference point is a point where a line perpendicularly extending from the touch point 41-2 intersects the left edge side of the screen 40 as illustrated in FIG. 13C. Then, the pointer cursor 42-3 is displayed in the position illustrated in FIG. 13C when the user's finger slides from the touch position 41-2 to the touch position 41-3 in the screen 40.

Further, as illustrated in FIG. 13D, when the finger slides from the touch position 41-4 to the touch position 41-5, the point position adjustment unit 15 switches the currently used expressions (33) to (36) to the expressions (31) to (33), so that the center point of the pointer cursor 42 is calculated. As a result, the pointer cursor 42-5 is set as illustrated in FIG. 13D in which the reference point is the point where a line perpendicularly extending from the touch position 41-5 intersects the right edge side of the screen 40. Then, when the user's finger slides from the touch position 41-5 to the touch position 41-6, the pointer cursor 42-6 is displayed in a position illustrated in FIG. 13D.

In the fixed mode according to the second embodiment, the switching of reference points and expressions not only can be performed when the touch position reaches the right edge of the screen 40 but can also be performed when the touch position reaches the left edge of the screen 40. Alternatively, the switching may be performed by using both the left and right edges of the screen 40.

The fixed mode of anyone of the above-described embodiments (first and second embodiments) may be partly or entirely combined with the fixed mode of another one or more of the above-described embodiments. Accordingly, even in a case where the fixed mode is used, operation can be performed without a blind spot in the screen 40 and without an area that is difficult to designate by performing the switching of reference points and expressions relative to four directions (lower edge, upper edge, right edge, left edge). Thus, a position in the entire screen 40 can be easily designated. Further, the fixed mode of any one of the above-described embodiments (first and second embodiments) may be partly or entirely combined with the position adjustment modes of the above-described embodiments. For example, various switching operations may be performed according to the point adjustment mode and the fixed mode of the above-described embodiments, so that the reference points and expressions can be sequentially switched according to a predetermined order and the pointer cursor can be displayed at a corresponding position.

### <Pointer Cursor>

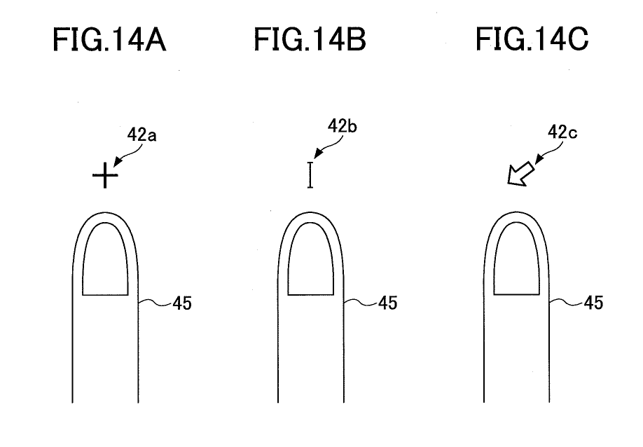

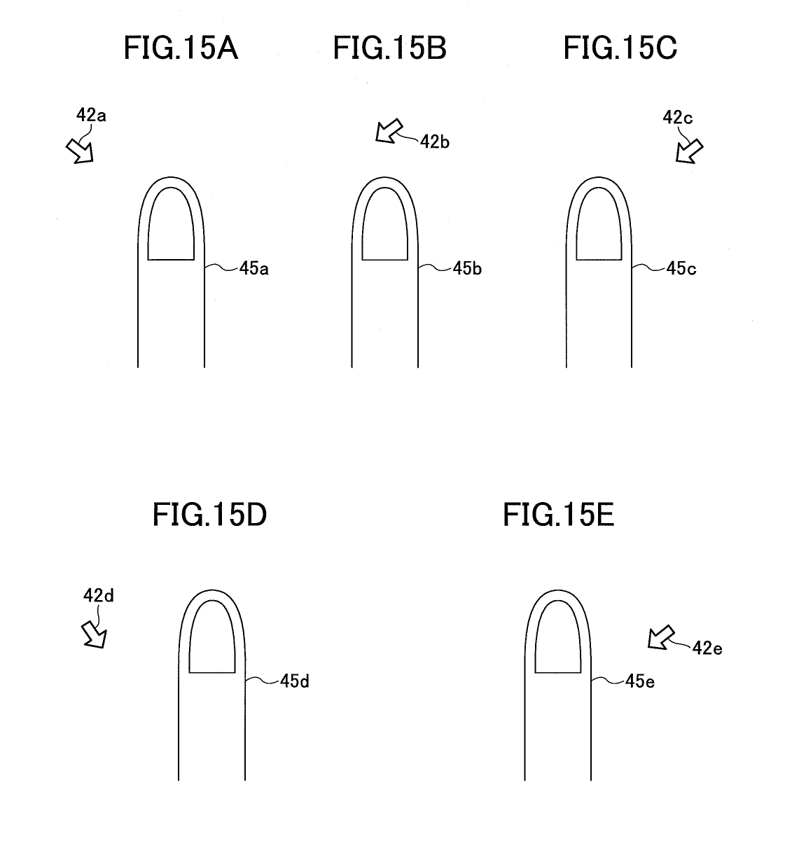

Next, the shape and display position of the pointer cursor according to an embodiment of the presenting is described with reference to the drawings. FIGS. 14A to 14C illustrate examples of the shapes of the pointer cursor. FIGS. 15A to 15E illustrate examples of the display positions of the pointer cursor according to an embodiment of the present invention.

According to an embodiment of the present invention, the pointer cursor 42 may have the shapes 42a to 42c illustrated in FIGS. 14A to 14C and be displayed in predetermined positions relative to the user's finger 45. However, the types and sizes of the pointer cursor 42 are not to be limited to those illustrated in FIGS. 14A to 14C.

As illustrated in FIGS. 14A to 14C, because the pointer cursor 42 is displayed in a position away from the finger 45 within the display area of the screen 40, the pointer cursor 42 can be easily matched to a desired position. Accordingly, the pointer cursor can be positioned at a desired position.

As illustrated in FIGS. 15A to 15E, the display position of the pointer cursor 42 according to an embodiment of the present invention may be displayed in any direction (e.g., pointer cursor positions 42a to 42e) in correspondence with the position of the finger relative to the reference point (predetermined point). The positions in which the pointer cursor 42 is displayed may be adjusted according to the above-described position adjustment mode or the fixed mode. Further, the pointer cursor 42 may be displayed in an appropriate position according to, for example, the type of the pointer cursor, the type of application being executed, or the content of the operation.

Note that the pointer cursor 42 is displayed when the finger 45 touches the screen. Further, the displayed pointer cursor 42 disappears when the finger 45 touching the screen 40 is released from the screen 40. For example, in a case where the finger 45 only touches the screen 40, the pointer cursor 42 is simply displayed on the screen 40. Thus, a subsequent action (operation) is desired for enabling a clicking process or the like.

For example, in a state where the finger is touching the screen 40, a click operation is performed by releasing the finger 45 from the screen 40 after sliding the finger 45 on the screen and matching the position of the pointer cursor 42 (moving in correspondence with the movement of the finger 45) with an operation target (e.g., icon, button) displayed on the screen 40. This operation is a standard click operation. The point at which the finger 45 is released is the clicked target. For example, in a case where a button displayed on the screen 40 is the target, the button is assumed to be clicked when the finger 45 touching the screen is released from the screen after the finger touching the screen 40 slides and moves the pointer cursor 43 on a position of the target button displayed on the screen. Accordingly, the control execution unit 14 performs controls to execute, for example, the application or program assigned to the button. Further, in this embodiment, a double-click operation can be performed by repeating the releasing action of the finger 45 when the pointer cursor 42 continues to remain on the button within a predetermined period after releasing the finger 45 from the screen 40.

Further, the designation of a range (area) by performing a drag operation according to an embodiment of the present invention is described as follows. A finger (first finger) that is contacting the screen 40 is moved while maintaining contact with the screen 40 to shift the position of the pointer cursor 42. Thereby, a point desired to be the start point is designated. Then, after pressing the screen 40 with a next finger and releasing the next finger from the screen 40, the first finger contacting the starting point is moved while maintaining contact with the screen 40, so that the range can be designated. Further, in the drag operation, a designation range (end point) can be defined by releasing the first finger that is contacting the screen 40 or by pressing the screen 40 with the next finger. Therefore, in designating a range in the screen 40 according to this embodiment, the user can positively confirm the positions of the start point and the end point of the range and designate the range. Accordingly, the user is prevented from making an erroneous designation. Thus, operability of the display process apparatus 10 can be improved.

Further, a context menu may be displayed on the screen 40 when two other fingers touches the screen 40 while the first finger is pressing the screen 40 (i.e., total of three fingers touching the screen 40). In a case of using multiple fingers, the fingers to be used are not limited in particular (e.g., thumb, index finger, middle finger, ring finger).

For example, in performing the drag operation, it is convenient to use the index finger to point at an area in the screen 40 while touching the screen 40 with the ring finger. Another convenient combination of operation is using the index finger to point at an area in the screen 40 while touching the screen 40 with the thumb. Further, the index fingers of both hands may also be used. Further, the fingers to be used for displaying the context menu are not limited in particular.

Further, the operations described above can be performed in the same manner whether the operations are performed by a right-handed person or a left-handed person. However, in a case of performing an operation requiring the use of multiple fingers, the use of one finger is preferable when performing a sliding operation on the screen 40 for designating a position in the screen 40. This is to avoid difficulty for the OS to determine which finger's coordinates is to be used for designating a position in a case where multiple fingers contacting the screen 40 slide simultaneously on the screen 40.

With the above-described embodiments, slight adjustments of the pointer cursor 42 can be performed whenever necessary. Further, because the pointer cursor 42 can be adjusted while visually confirming the adjustments, the pointer cursor 42 can be positioned without error. With the above-described embodiments, an operation such as a click operation can be performed with the same accuracy as performing the operation with a pointing device (e.g., mouse). With the above-described embodiments, a conventional pointing device such as a mouse or a touch-pad of a PC can be used together with the display process apparatus 10. Further, even in a case where such pointing device is connected to the display process apparatus 10, the pointer cursor 42 moves toward the position of a finger when the finger is placed on the screen 40, so that an operation can be performed with the finger.

With the above-described embodiments, the position information visually obtained by the user serves as feed back to the movement of the finger. Therefore, a precise position in the screen 40 can be accurately designated. In a case of designating such position, a more precise point can be designated by rolling (moving) a fingertip of a user's finger in a desired direction while touching the screen 40 with the user's finger.

### Applied Example Using the Embodiments

Next, applied examples using the display control process of the above-described embodiments are described.

### First Applied Example

### Copy & Paste of Sentence

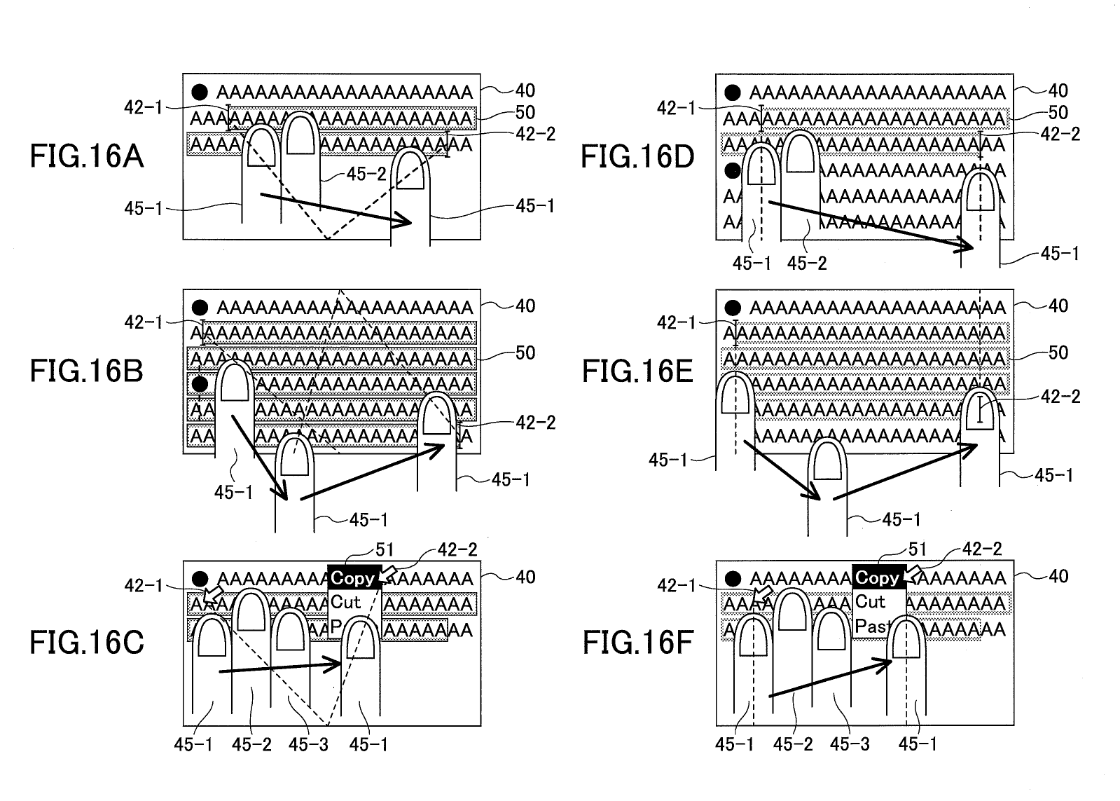

FIGS. 16A to 16F are schematic diagrams illustrating the first applied example of the above-described embodiments. In the first applied example, a copy & paste operation of a sentence or the like is performed by using a text editing application installed in the display process apparatus (e.g., smartphone, tablet terminal) 10 where the position adjustment mode or the fixed mode is used.

Conventionally, an operation of accurately designating a start position and an end position in 1 character units can be difficult and burdensome when attempting to designate a range to be copied (copy range). However, by applying the above-described embodiments to a copy & paste operation, a precise position of a point can be designated. For example, the position of the point of the screen 40 can be precisely designated in dot units. In the first applied example, the operation to which the above-described embodiments are applied is not limited to a copy & paste operation. For example, the above-described embodiments may also be applied to a cut operation or a cut & paste operation. With the first applied example, the user's work-efficiency can be improved along with improving editing efficiency of a sentence or the like.

FIGS. 16A to 16C illustrate examples of designating a copy range of a sentence according to the position adjustment mode of the first embodiment. FIGS. 16D to 16F illustrate examples of designating a copy range of a sentence according to the fixed mode of the first embodiment. The data of the sentence (text data) is displayed on the screen 40. Note that the character “A” indicated in FIGS. 16A to 16F corresponds to a single character of a predetermined kanji (Chinese character), a letter, or a number. In the first applied example, whether to use the position adjustment mode or the fixed mode may be set depending on the type of application or the settings being set beforehand by the user.

In a case of performing a copy & paste operation on a portion of text data as illustrated in FIG. 16A, the pointer cursor 42-1 is matched with a start point of a copy target by using a first finger 45-1, and then, the screen 40 is tapped by using a second finger 45-2. Thereby, a mode for designating a copy area is set.

Then, a drag operation is performed by sliding the first finger 45-1 on the screen 40 while the first finger 45-1 remains in contact with the screen 40. Then, by positioning the pointer cursor 42-2 to the position of an end point and releasing the first finger 45-2 from the screen 40, a drag range (designation range) 50 is defined.

FIG. 16B depicts an example of designating a drag range of a sentence while switching the display position of the pointer cursor by using the position adjustment mode. In the example of FIG. 16B, the expression for calculating the center of the pointer cursor 42-1 is switched when the finger 45-1 touches the lower edge of the screen 40 during a drag operation. The calculation is performed by assuming that the upper edge center of the screen 40 is the reference point (predetermined point). Thereby, the pointer cursor 42-1 is displayed in a calculated position. In the example of FIG. 16B, the pointer cursor 42-2 is displayed in the lower right of the touch position of the finger 45-1. Therefore, the user can easily designate a lower area of the screen 40. Thus, a precise drag range can be designated.

FIG. 16C depicts an example of displaying a context menu by using the position adjustment mode and selecting an item in the context menu. In the example of FIG. 16C, after selecting a copy range by performing a drag operation, a context menu 51 is displayed by simultaneously tapping the screen 40 with three fingers 45-1 to 45-3. Then, a function in the context menu 51 is selected by touching the screen 40 with the first finger 45-1, selecting a target item from the context menu, and releasing the finger 45-1 from the screen 40. Thereby, the selected function is executed. Although an arrow is displayed as the pointer cursor for selecting an item from the context menu, the type of the pointer cursor is not limited to the arrow type pointer cursor.

FIG. 16D depicts an example of designating a copy range of a sentence by using a fixed mode. In a case of performing a copy & paste operation on a portion of text data illustrated in FIG. 16D, the pointer cursor 42-1 is matched with a start point of a copy target by using a first finger 45-1, and then, the screen 40 is tapped by using a second finger 45-2. Thereby, a mode for designating a copy area is set.

Then, a drag operation is performed by sliding the first finger 45-1 on the screen 40 while the first finger 45-1 remains in contact with the screen 40. Then, by positioning the pointer cursor 42-2 to the position of an end point and releasing the first finger 45-2 from the screen 40, a drag range 50 is defined.

FIG. 16E depicts an example of designating a drag range of a sentence while switching the display position of the pointer cursor by using the fixed mode. In the example of FIG. 16E, the expression for calculating the center of the pointer cursor 42-1 is switched when the finger 45-1 touches the lower edge of the screen 40 during a drag operation. The calculation is performed by assuming that a point perpendicularly extending from the touch position to the upper edge of the screen 40 is the reference point (predetermined point). Thereby, the pointer cursor 42-1 is displayed in a calculated position. In the example of FIG. 16E, the pointer cursor 42-2 is displayed in a position proximal to the touch position of the finger 45-1, the pointer cursor 42-2 may be hidden by the finger 45-1 such that the user cannot sufficiently see the pointer cursor 42-2. However, the user can estimate the position of the pointer cursor 42-2 because the fixed mode is being used. In FIG. 16E, a drag range is defined to be in the range of the pointer cursors 42-1 to 42-2 by releasing the finger 45-1 from the screen 40 at the position of the pointer cursor 42-2.

FIG. 16F depicts an example of displaying a context menu by using the fixed mode and selecting an item in the context menu. In the example of FIG. 16F, after selecting a copy range by performing a drag operation, a context menu 51 is displayed by simultaneously tapping the screen 40 with three fingers 45-1 to 45-3. Then, a function in the context menu 51 is selected by touching the screen 40 with the first finger 45-1, selecting a target item from the context menu, and releasing the finger 45-1 from the screen 40. Thereby, the selected function is executed. Although an arrow is displayed as the pointer cursor for selecting an item from the context menu, the type of the pointer cursor is not limited to the arrow type pointer cursor.

### Second Applied Example

### Drawing of a Figure

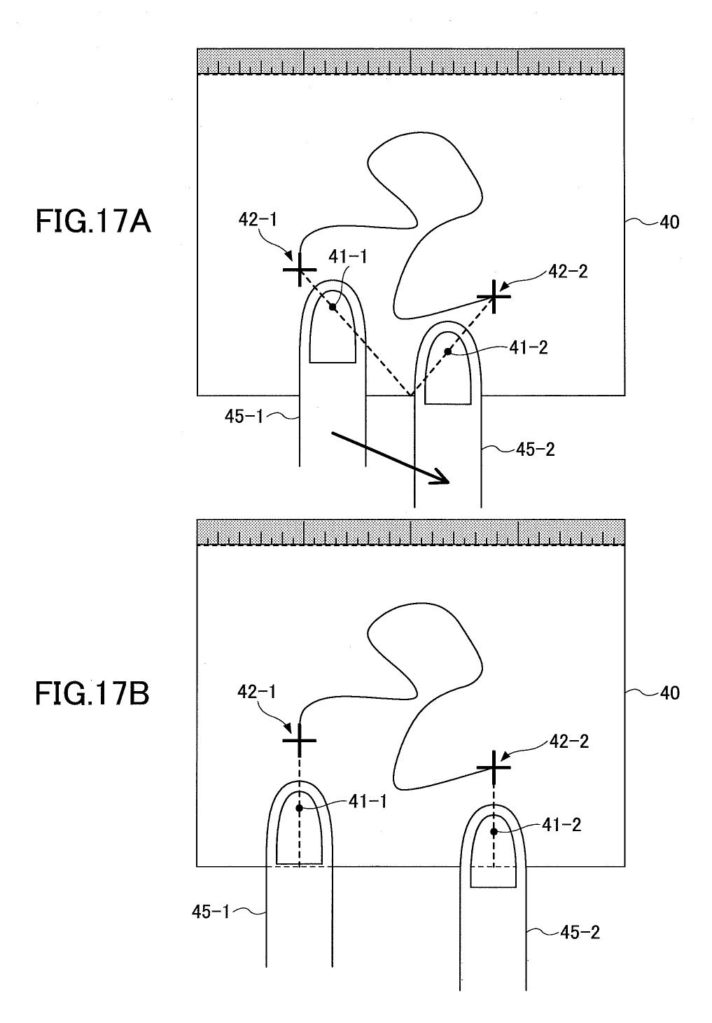

FIGS. 17A and 17B are schematic diagrams illustrating the second applied example of the above-described embodiments. In the second applied example, a figure drawing operation is performed by using a figure drawing application installed beforehand in the display process apparatus 10 where the position adjustment mode or the fixed mode is used.

Conventionally, in a case of drawing a fine figure by free hand, it was almost impossible to designate a start point, an end point, and an intersection point of the figure. However, by applying the above-described embodiments to the figure drawing operation, a start point, an end point, and an intersection point of a fine figure can easily be designated by position designation. Thus, a fine figure can be easily drawn.

FIG. 17A illustrates an example of drawing a figure according to the position adjustment mode of the first embodiment. FIG. 17B illustrates an example of drawing a figure according to the fixed mode of the first embodiment. In the second applied example, whether to use the position adjustment mode or the fixed mode may be set depending on the type of application or the settings being set beforehand by the user.

For example, in a case of drawing a linear figure by using the position adjustment mode as illustrated in FIG. 17A, the linear figure can be easily drawn because the user can draw while viewing the position of the pointer cursor 42. Further, in a case of drawing a linear figure by using the fixed mode as illustrated in FIG. 17B, the pointer cursor 42 and the finger 45 are oriented in a consistent direction (e.g., in the example illustrated in FIG. 17B, the pointer cursor 42 is consistently positioned higher than the finger 45). Therefore, a precise figure can be easily drawn. Further, in the second applied example, conditions for displaying the pointer cursor 42 (e.g., reference point, expression) can be easily switched by sliding (moving) the touch position or the pointer cursor 42 to an edge part of the screen 40. Accordingly, an appropriate selection can be made throughout the entire area of the screen 40.

### Third Applied Example

### Operation of Menu and Tool Bar

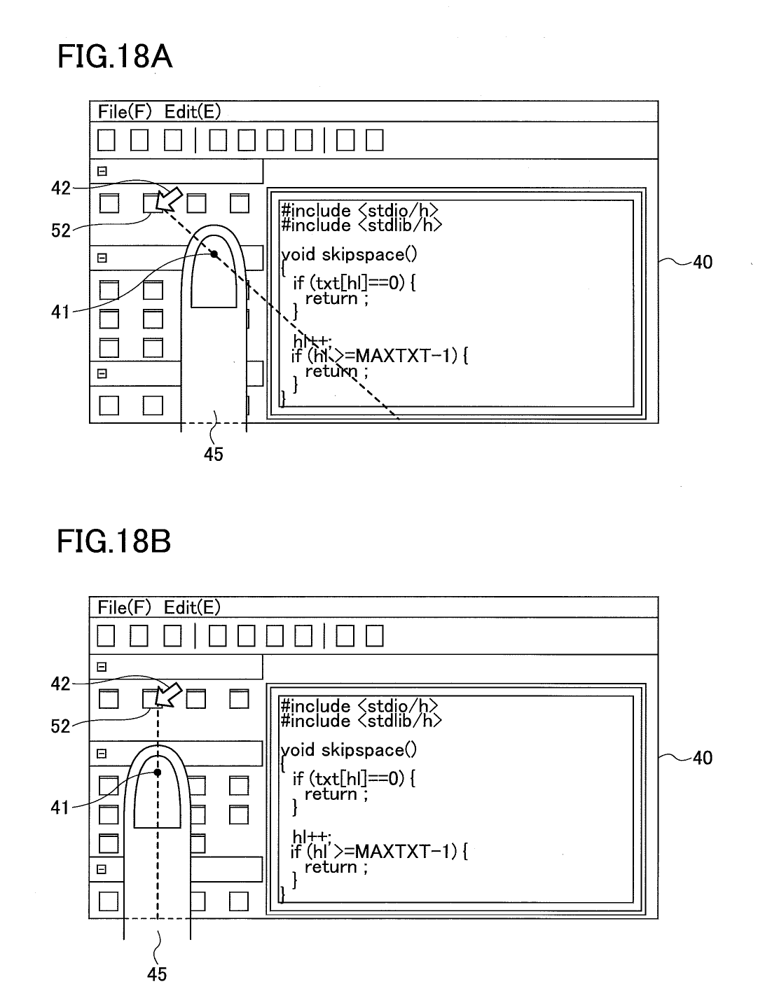

FIGS. 18A and 18B are schematic diagrams illustrating the third applied example of the above-described embodiments. In the third applied example, a program creating operation is performed by using a programming application installed beforehand in the display process apparatus 10 where the position adjustment mode or the fixed mode is used.

For example, in a case of performing operations such as compiling and debugging when creating a program source in the screen 40, an IDE (Integrated Development Environment) function is used by operating a fine-sized menu or toolbar.

Conventionally, in a case of directly pressing fine-sized buttons arranged on the screen 40 with the finger 45, the user inadvertently select a button next to an intended button due to a cursor being hidden by the finger 45. However, by applying the above-described embodiments to a program creating operation that include operating a menu or a toolbar, the user is prevented from inadvertently pressing an unintended button owing to the click operation that is performed by touching the screen 40 with the finger 45, selecting the correct (intended) button with the pointer cursor 42, and releasing the finger 45 from the screen 40. Therefore, even in a case of operating fine-sized buttons arranged on the screen 40, the user can quickly click the correct button.

FIG. 18A illustrates an example of displaying a pointer cursor according to the position adjustment mode of the first embodiment. FIG. 18B illustrates an example of displaying a pointer cursor according to the fixed mode of the first embodiment. In the third applied example, whether to use the position adjustment mode or the fixed mode may be set depending on the type of application or the settings being set beforehand by the user.

In the third applied example, the selection of buttons that are smaller than the finger 45 can be easily performed for both the position adjustment mode and the fixed mode as illustrated in FIGS. 18A and 18B. Further, in the third applied example, conditions for displaying the pointer cursor 42 (e.g., reference point, expression) can be easily switched by sliding (moving) the touch position or the pointer cursor 42 to an edge part of the screen 40. Accordingly, an appropriate selection can be made throughout the entire area of the screen 40.

### Fourth Applied Example

### Drafting of Design Drawing

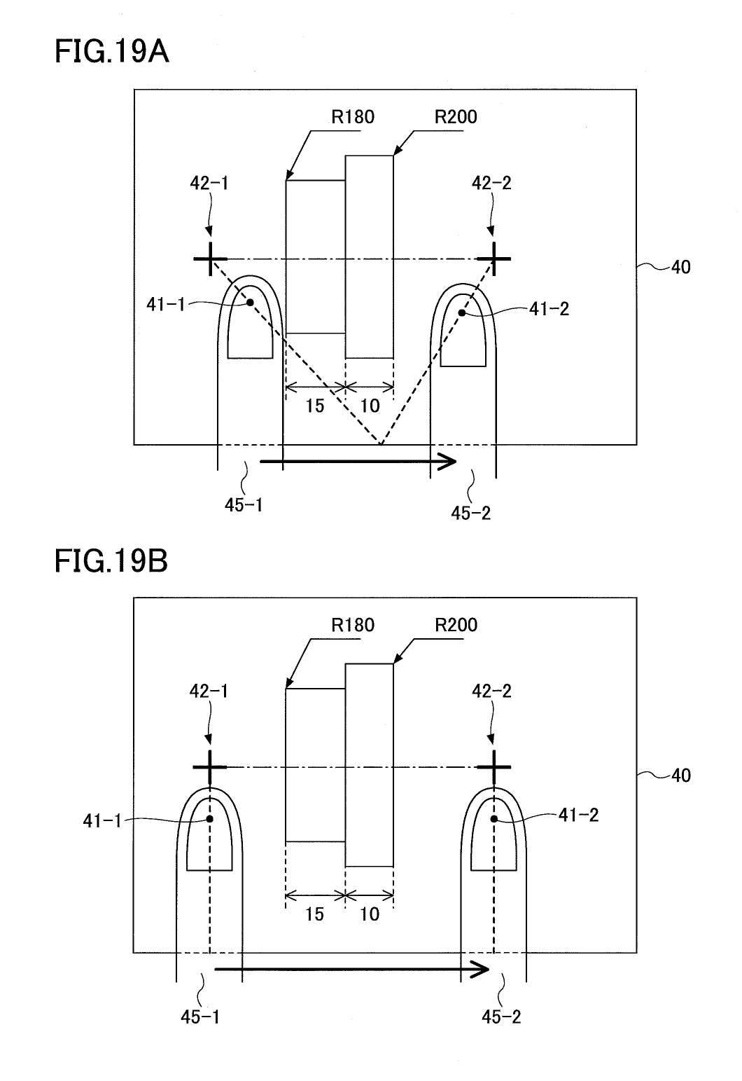

FIGS. 19A and 19B are schematic diagrams illustrating the fourth applied example of the above-described embodiments. In the fourth applied example, a design drawing (e.g., design drawing of a precise mechanical device) is drafted on the screen 40 by using a CAD application installed beforehand in the display process apparatus 10 where the position adjustment mode or the fixed mode is used.

FIG. 19A illustrates an example of displaying a pointer cursor according to the position adjustment mode of the first embodiment. FIG. 19B illustrates an example of displaying a pointer cursor according to the fixed mode of the first embodiment. In the fourth applied example, whether to use the position adjustment mode or the fixed mode may be set depending on the type of application or the settings being set beforehand by the user.

FIGS. 19A and 19B depict examples of drawing a center line across the screen 40 by moving the finger from the touch position 41-1 to the touch position 41-2. In order to draft a design drawing, positions are to be precisely designated. Conventionally, precise operation may be difficult due to a display position of a pointer cursor being hidden by a finger. However, by applying the above-described embodiments to a design-drawing drafting operation, positions on the screen 40 can be precisely designated. Thus, a precise drawing can be drafted with a CAD program.

In performing a CAD operation by using the position adjustment mode, the pointer cursor 42 is displayed in a position based on the lower edge center of the screen 40 as illustrated in FIG. 19A. Therefore, the pointer cursor 42 is prevented from being hidden by finger, and the pointer cursor 42 can be easily positioned. Accordingly, a precise drawing can be drafted with the position adjustment mode.

In performing a CAD operation by using the fixed mode, the position in which the pointer cursor 42 is displayed relative to the position of the finger 45 is fixed. Therefore, the user can easily designate a position in the screen 40. Further, in the fourth applied example, conditions for displaying the pointer cursor 42 (e.g., reference point, expression) can be easily switched by sliding (moving) the touch position or the pointer cursor 42 to an edge part of the screen 40. Accordingly, an appropriate selection can be made throughout the entire area of the screen 40.

### Fifth Applied Example

### Selection of Cell of Spreadsheet Software

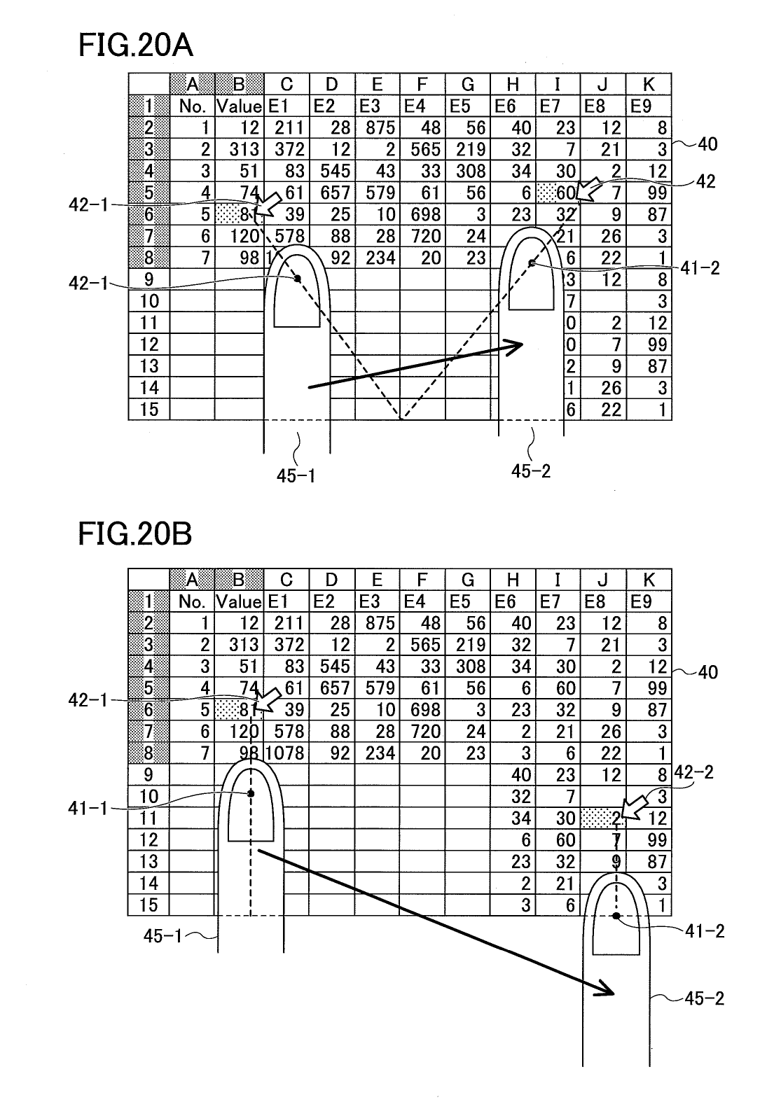

FIGS. 20A and 20B are schematic diagrams illustrating the fifth applied example of the above-described embodiments. In the fifth applied example, fine-sized cells on the screen 40 are designated by using spreadsheet software installed beforehand in the display process apparatus 10 where the position adjustment mode or the fixed mode is used.

Conventionally, when selecting a cell or inputting data into a cell in a case where the sizes of cells of spreadsheet software are reduced, the user may have difficulty in distinguishing cells located near each other and make an erroneous operation. Further, if the sizes of cells are increased, the number of cells that can be displayed with a terminal having a small display (e.g., smartphone, tablet terminal) becomes limited. Thus, amount of data displayed on the screen is reduced.

However, by applying the above-described embodiments to a cell selection operation, the pointer cursor 42 can be positioned in a desired point without operation difficulty even if the sizes of cells are reduced. Therefore, operation efficiency can be improved.

FIG. 20A illustrates an example of selecting a cell according to the position adjustment mode of the first embodiment. FIG. 20B illustrates an example of selecting a cell according to the fixed mode of the first embodiment. In the fifth applied example, whether to use the position adjustment mode or the fixed mode may be set depending on the type of application or the settings being set beforehand by the user.

FIG. 20A depicts an example of designating a cell of spreadsheet software by using the position adjustment mode. In the example of FIG. 20A, the position of the pointer cursor 42 is displayed in a position calculated by a predetermined expression according to a touch position in which the lower edge center of the screen 40 serves as the reference point (predetermined point). Accordingly, the pointer cursor 42 displayed in the screen 40 is prevented from being constantly hidden by the finger 45. Thus, a fine-sized cell or a corner of the cell can be designated. Accordingly, a spreadsheet operation can be performed with the same accuracy as performing the operation with a pointing device such as a mouse.

FIG. 20B depicts an example of designating a cell of spreadsheet software by using the fixed mode. In designating a cell by using the fixed mode, the position in which the pointer cursor 42 is displayed relative to the position of the finger 45 is fixed as illustrated in FIG. 20B. That is, in the example illustrated in FIG. 20B, the pointer cursor 42 is fixed to be positioned higher than the finger 45. Therefore, the user can easily designate a position in the screen 40. Further, in the fifth applied example, conditions for displaying the pointer cursor 42 (e.g., reference point, expression) can be easily switched by sliding (moving) the touch position or the pointer cursor 42 to an edge part of the screen 40. Accordingly, an appropriate selection can be made throughout the entire area of the screen 40.

<Configuration without Switching of Expressions Based on Arrangement of Buttons or the Like>

In the above-described embodiments, a corresponding expressions are switched when the touch position reaches a side rim of the screen 40 (screen edge). However, the pointer cursor 42 may be displayed without switching expressions depending on, for example, the type of application. For example, the point position adjustment unit 15 the center point of the pointer cursor 42 may be calculated without switching predetermined expressions based on the arrangement of buttons or the like displayed on the screen 40.

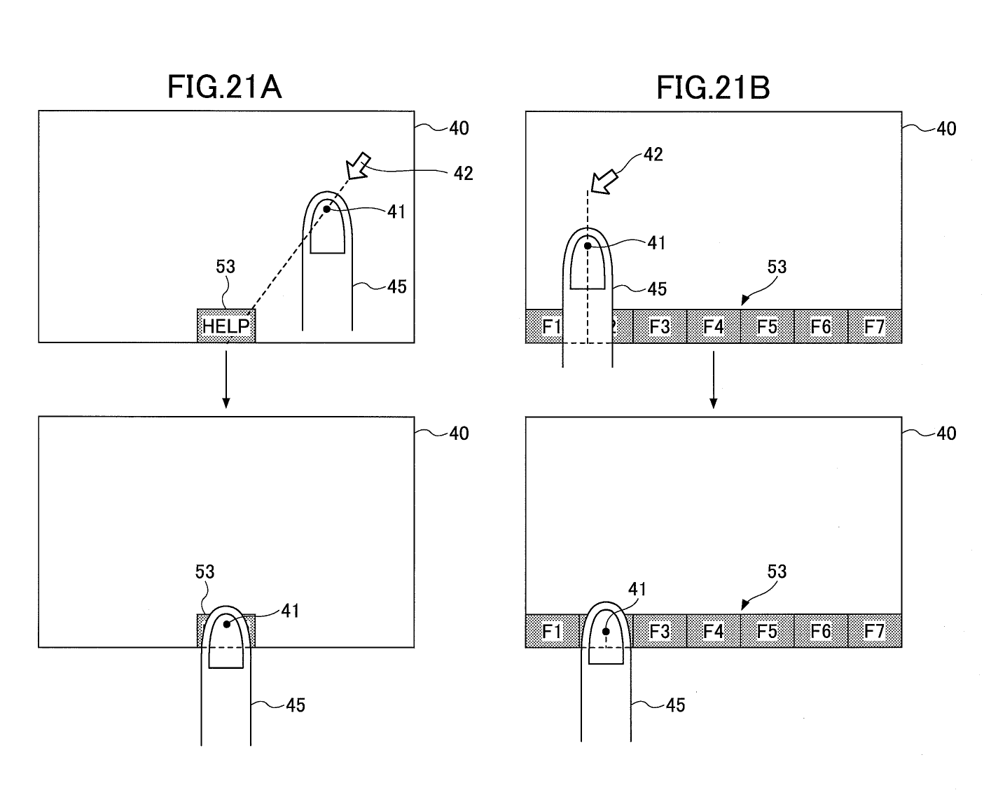

FIGS. 21A and 21B are schematic diagrams illustrating the fifth applied example of the above-described embodiments. FIG. 21A depicts an example of displaying a pointer cursor according to the position adjustment mode of the first embodiment in a case where a button (e.g., help button) is arranged in the vicinity of the screen's lower edge center that serves as a reference point (converging point). In this case, any area in the screen 40 except for the area of the button 53 can be designated without difficulty because the user can visually confirm the pointer cursor 42 by positioning the pointer cursor 42 away from the finger 45. Further, by moving the touch position to the position of the button 53, the button 53 can easily be selected even where the pointer cursor 42 is hidden under the finger. Accordingly, in these cases, the point position adjustment unit 15 can perform various controls without the switching of expressions. Therefore, by arranging the button 53 in accordance with the position of the reference point, a position can be designated (pointed) throughout the screen 40 without having to switch the reference points or expressions.

FIG. 21B depicts an example of displaying a pointer cursor according to the fixed mode of the first embodiment in a case where buttons (e.g., function buttons (F1-F7)) are arranged side-by-side from the touch position 41 at the lower edge of the screen 40. In this case, although the pointer cursor 42 becomes hidden by the finger 45 when the touch position 41 is lowered, a position can be designated (pointed) throughout the screen 40 without having to switch the reference points or expressions.

Hence, in the above-described embodiments, the switching of modes, reference points, and expressions may be switched according to the arrangement of the buttons 53 in the screen 40 for enabling the buttons to be pressed. Further, the display control unit 16 may performs controls to change the layout of buttons 53 displayed in the screen 40 depending on whether the position adjustment mode or the fixed mode is used.

Further, with the above-described embodiments, the operability of the display process apparatus 10 can be improved. For example, an operation with a finger can be performed on the screen 40 with the same precision and ease as operating with a mouse. Further, a position in the screen 40 can be designated in dot units. Similar to the UI (User Interface) of an OS using a mouse (e.g., Windows (registered trademark), Linux (registered trademark), positions in a screen 40 can be precisely operated. Thus, an interface that provides the same precision and speed as a mouse can be implemented by the touch screen operation with a finger according to the above-described embodiments.

Further, with the above-described embodiments, positions in a screen can be designated with high precision. Further, conventional applications including easy-to-use multi-windows can be operated without difficulty. Because a precise position for performing a copy & paste operation can be easily designated, the above-described embodiments can be applied for purposes such as writing lengthy text or creating programs. Further, a table terminal or a smartphone can be used for creative purposes such as CAD operation and CG creation.

The expressions used in the above-described embodiments are calculated based on a case where the upper left corner is the origin point of a coordinate system. However, in a case where another position in the coordinate system is assumed to be the origin point, expressions corresponding to the another position of the coordinate system are to be used. Further, the first point in the above-described embodiments is not limited to the touch position. Further, the second point in the above-described embodiments is not limited to the position at which the pointer cursor is displayed in the screen (e.g., center point).

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A display process apparatus comprising:
a screen; and
a processor that executes a process including
identifying a first point in a display area of the screen according to an input operation performed on the display process apparatus, and
distinguishably displaying a second point in the display area;
wherein the second point is positioned a predetermined distance from the first point, and
wherein the second point is positioned on a half-straight line extending toward the first point from a predetermined point that is set at an edge part of the display area.

2. The display process apparatus as claimed in claim 1, wherein the process executed by the processor further includes distinguishably displaying the second point in a position at which a distance between the first point and the second point is greater than a distance between a distance between the first point and the predetermined point according to the input operation.

3. The display process apparatus as claimed in claim 1, wherein the process executed by the processor further includes changing a distance between the first point and the second point according to a distance between the predetermined point and the first point in a case where the distance between the predetermined point and the first point is less than a predetermined value.

4. The display process apparatus as claimed in claim 3, wherein the changing includes changing the predetermined point to another predetermined point in a case where the first point is positioned in a predetermined position.

5. The display process apparatus as claimed 4, wherein the changing includes changing the predetermined point to another predetermined point in a case where the first point is identified to have reached the edge part of the display area.

6. The display process apparatus as claimed in claim 3,
wherein the process executed by the processor further includes calculating a position of the second point relative to the first point by using an expression, and
wherein the expression is determined according to a predetermined display mode for displaying the second point and a position of the predetermined point.

7. The display process apparatus as claimed in claim 1, wherein the identifying includes identifying a designated point to be the second point in a case where coordinates of the designated point is input along with the input operation.

8. A display process method comprising:
identifying a first point in a display area of a screen of a display process apparatus according to an input operation performed on the display process apparatus, and
distinguishably displaying a second point in the display area;
wherein the second point is positioned a predetermined distance from the first point, and
wherein the second point is positioned on a half-straight line extending toward the first point from a predetermined point that is set at an edge part of the display area.

9. A non-transitory recording medium storing a program that causes a processor of a display process apparatus to execute a process, the process comprising:
identifying a first point in a display area of a screen of the display process apparatus according to an input operation performed on the display process apparatus, and
distinguishably displaying a second point in the display area;
wherein the second point is positioned a predetermined distance from the first point, and
wherein the second point is positioned on a half-straight line extending toward the first point from a predetermined point that is set at an edge part of the display area.
